(19) United States
(12) Patent Application Publication
(10) Pub. No.: US 2026/0080636 A1
(43) Pub. Date: Mar. 19, 2026

(54) AUTOMATED CREATION OF AUGMENTED REALITY EXPERIENCES USING MULTI-AGENT LANGUAGE MODELS

(71) Applicant: Snap Inc., Santa Monica, CA (US)

(72) Inventors: Jacob Assa, New York, NY (US); Avihay Assouline, New York, NY (US); Itamar Berger, Hod Hasharon (IL); Amir Fruchtman, Holon (IL); Sergei Korolev, Playa Vista, CA (US); Gal Sasson, Kibbutz Ayyelet Hashahar (IL); Roman Shtemberko, Topanga, CA (US); Jonathan Solichin, Arcadia, CA (US); Trevor Stephenson, Camarillo, CA (US); Aleksei Stoliar, Los Angeles, CA (US)

(21) Appl. No.: 19/323,527

(22) Filed: Sep. 9, 2025

Related U.S. Application Data
(60) Provisional application No. 63/695,250, filed on Sep. 16, 2024.

(51) Int. Cl. G06T 19/00; G06F 40/40; G06T 11/00; G06T 19/20

(52) U.S. Cl. CPC G06T 19/006; G06F 40/40; G06T 11/00; G06T 19/20; G06T 2219/2004

(57) ABSTRACT

The subject matter describe herein relates to a system and method for creating augmented reality (AR) applications using artificial intelligence. The system comprises a multi-agent architecture including a lens or AR content creator agent, AR engineer agent, and designer agent that collaborate to generate AR application designs based on user input. A content management system stores reusable components and asset generators provide customized visual elements. The user interface allows natural language interactions to iteratively refine the AR application. The system leverages large language models and retrieval-augmented generation to construct appropriate prompts and select relevant components. Generated designs are assembled into executable AR applications using a plugin that interfaces with an AR development environment. This AI-assisted approach enables rapid creation of diverse, engaging AR experiences with minimal technical expertise required from users.

### CROSS-REFERENCE TO RELATED APPLICATION

This patent application claims the benefit of U.S. Provisional Patent Application No. 63/695,250, filed Sep. 16, 2024, which is incorporated by reference herein in its entirety.

### TECHNICAL FIELD

The technical field of the subject matter set forth herein relates to techniques, including systems and methods, for the automated creation of augmented reality (AR) experiences using artificial intelligence (AI), specifically employing multi-agent language models and generative asset creation techniques. The techniques particularly pertain to the domain of computer-implemented augmented reality application development, focusing on lowering the barrier to entry for creators with limited to no development experience. Additionally, the technical field encompasses the integration of large language models, computer vision, and 3D modeling technologies to facilitate the rapid prototyping and generation of interactive augmented reality content.

### BACKGROUND

In recent years, augmented reality (AR) technology has become increasingly popular, driven by applications such as Snapchat®, and its feature known as Lenses®, as well as other social media platforms that allow users to interact with digital content overlaid on their physical environment. However, the creation of customized AR effects often requires specialized knowledge of programming and design tools, making it inaccessible to many users, including those with creative ideas but limited technical expertise. Current AR development environments can be complex and resource-intensive, requiring developers to invest significant time and effort in building and deploying customized AR experiences. As AR continues to grow in popularity, there is a need for a simplified and intuitive system that enables users of all skill levels to create and deploy personalized AR effects, making this innovative technology more accessible to a broader audience.

### BRIEF DESCRIPTION OF THE FIGURES

The figures illustrate various aspects of an AI-powered system for creating augmented reality experiences. These figures depict the system architecture, component interactions, data flows, and user interfaces that enable the automated generation of AR experiences through natural language interactions and AI-driven processes.

FIG. 1 is a system architecture diagram illustrating the components and interactions of an AI-based AR content creation system (e.g., AR content creation), consistent with some examples.

FIG. 2 is a diagram showing the tasks, tools, and interactions of the LLM Agents in the AI-based AR content creation system, consistent with some examples.

FIG. 3 is a diagram depicting the relationship between Asset Generators and AR Content Blocks in the AI-based AR content creation system, consistent with some examples.

FIG. 4 illustrates the 3D Ears block, which adds 3D head-bound ears with generated textures, and the Background block, which applies a prompt-generated background image to transport the user to a different environment based on the AR experience theme, consistent with some examples.

FIG. 5 depicts the 3D Glasses block, which adds 3D glasses from the Bitmoji library with generated textures, and the 3D Headwear block, which adds 3D hats from the Bitmoji library with generated textures, consistent with some examples.

FIG. 6 shows the 2D Hat block, which creates a 2D hat or hat-like visual that tracks a user's head based on the AR experience theme, and the Color Filter block, which recolors the entire scene based on a prompt by generating an image that abstractly represents the AR experience theme.

FIG. 7 illustrates the Text On Head block, which creates theme-related text bound to the user's head, and the Text On Screen block, which positions theme-related text at a point on the screen.

FIG. 8 depicts the Garment block, which generates a garment based on the AR experience prompt and transfers it onto the user in real-time, and the Face Events block, which uses facial expressions as input to influence other block parameters.

FIG. 9 shows the Face Mask block, which creates a face mask effect, and the 3D Object On Body block, which places a 3D object on the user's head or shoulder.

FIG. 10 illustrates the Particle Effects block, which creates multiple instances of an image moving through the scene, and the Face Deformation block, which transforms the user's face using Blendshapes.

FIG. 11 depicts the Face In Image block, which applies caricatured versions of the user's eyes and mouth onto an image that moves with their head, and the Beautification block, which applies machine learning-based touch-up and makeup effects.

FIG. 12 shows the Sticker On Screen block, which creates a 2D sticker-like image positioned on the screen, and the Sticker On Face block, which creates a 2D sticker-like image bound to the user's head.

FIG. 13 illustrates the Bitmoji On Shoulder block, which places a 3D Bitmoji on the user's shoulder, and the Head Particles block, which creates head-bound VFX particles.

FIG. 14 depicts the Face Cutout block, which creates a background image with a cut-out hole for the user's face, and the 3D Object Crown block, which makes 3D objects revolve around the user's head.

FIG. 15 is a diagram illustrating the integration of various APIs and services with the AILC Plugin in Lens Studio-AR content creation system, consistent with some examples.

FIG. 16 is a flowchart showing the process of creating an AR experience using the AI content creation system, consistent with some examples.

FIG. 17 is a system architecture diagram detailing the backend components and their interactions with an AR content creatin system, consistent with some examples.

FIG. 18 is an alternative system architecture diagram showing a routing layer for message handling in the AI-based AR content creation system backend, consistent with some examples.

FIG. 19 is a simplified system architecture diagram highlighting the WebSocket communication between the Web UI and CrewAI, according to some examples.

FIG. 20 is a system architecture diagram emphasizing the authentication process in the AI-based AR content creation system backend, consistent with some examples.

FIG. 21 is a detailed system architecture diagram showing the message handling and CrewAI service integration in the AI-based AR content creation system backend, according to some examples.

FIG. 22 is an alternative system architecture diagram incorporating Temporal workflow for CrewAI instance management, according to some examples.

FIG. 23 is a diagram illustrating the preprocessing and inference stages of the AI AR content creation system, according to some examples.

FIG. 24 is a diagram depicting the process of constructing augmented prompts using vector databases and user input, consistent with some examples.

FIG. 25 is a user interface screenshot of the AI-based AR content creation system, showing example prompts for AR experience creation.

### DETAILED DESCRIPTION

The present disclosure relates to techniques, including systems and methods, for the automated creation of augmented reality (AR) experiences using multi-agent language models. The system described herein provides a novel approach to AR experience creation by leveraging a multi-agent Large Language Model (LLM) based architecture to simplify the process and lower the barrier to entry for creators with limited to no development experience. This system enables the rapid prototyping and generation of interactive AR content through a conversational interface, integrating advanced artificial intelligence techniques with computer vision and 3D modeling technologies. By automating various aspects of the AR experience creation process, including concept generation, asset creation, and interaction design, the system significantly reduces the complexity and time required to develop engaging AR applications.

The creation of augmented reality (AR) experiences using conventional techniques presents significant technical challenges that make the process complex, time-consuming, and inaccessible to many potential creators. Traditionally, building successful AR experiences requires a combination of multiple specialized skills and expertise, including 3D modeling, game development, concept art, UX/UI design, and AR engineering. This multidisciplinary nature of AR development often necessitates a team of professionals working together, which can take several weeks to construct a single AR experience.

Using existing tools, the process of creating an AR effect or experience is highly technical and demanding. It typically involves:
Conceptualization and planning of the AR experience, which requires a deep understanding of AR capabilities and user interaction design.
Development of the AR experience using complex programming environments and SDKs, necessitating proficiency in coding and software development.
Creation of 3D models, textures, and other visual assets, which demands expertise in 3D modeling software and computer graphics.
Implementation of computer vision algorithms for features like face tracking or object recognition, requiring advanced knowledge in image processing and machine learning.
Optimization of the AR experience for performance on mobile devices, which involves intricate knowledge of hardware limitations and optimization techniques.
Testing and debugging across various devices and scenarios, a time-consuming process that requires technical proficiency in software testing methodologies.

The complexity of this process is further exacerbated by the rapid evolution of AR technologies, which constantly introduces new features and capabilities that creators must learn and integrate. This fast-paced technological landscape makes it challenging even for experienced developers to keep up with the latest trends and best practices in AR development. Moreover, the existing tools often suffer from limitations when it comes to AI-assisted AR creation. For instance, AI-based code generation tools frequently produce hallucinations, assuming capabilities and features that don't exist in the AR platform. This leads to unpredictable generation quality, where the automatically generated artifacts may not work at all, requiring high-level skills to update and fix the output. The lack of coherent and consistent documentation in many AR development platforms further compounds these issues, making it difficult for creators to understand and utilize the full range of available features. Additionally, the rapid rate at which new features are incorporated into AR platforms limits the ability to create stable, trainable datasets for AI-assisted development.

These technical challenges collectively create a high barrier to entry for AR experience creation, limiting the pool of potential creators and stifling innovation in the field. The conventional techniques not only require a steep learning curve but also demand significant time and resources, making it particularly difficult for individuals or small teams to create engaging and diverse AR experiences efficiently.

While some efforts have been made to develop tools aimed at simplifying the creation of augmented reality (AR) experiences for the average person, these tools still present significant challenges that often exceed the capabilities of non-technical users. Even with such simplified development environments, creating engaging AR experiences typically requires a diverse set of skills and knowledge that is beyond the reach of most individuals. These tools, while more accessible than traditional AR development methods, still demand a substantial understanding of various technical domains. Users often need to grasp concepts related to 3D modeling, game development, user interface design, and AR-specific programming.

The learning curve associated with these tools can be steep, requiring users to invest significant time and effort to become proficient. Moreover, staying current with the rapidly evolving AR technology landscape adds another layer of complexity, as users must continually update their skills to leverage new features and capabilities. As a result, even with these simplified tools, the creation of high-quality, engaging AR experiences remains a complex task that is often out of reach for the average person without extensive technical background or dedicated time for learning. This limitation continues to present a barrier to widespread adoption and innovation in AR content creation, highlighting the need for more intuitive and accessible solutions that can truly democratize AR development for users of all skill levels.

The innovative subject matter set forth herein presents a novel solution to the challenges of augmented reality (AR) experience creation through a multi-agent Large Language Model (LLM) based system. This system, referred to herein as Easy Lens, provides a conversational interface that significantly simplifies the process of creating AR experiences, making it accessible to users with limited to no development experience. At its core, the system employs a hierarchical multi-agent architecture consisting of specialized agents, including a Lens Creator Agent, AR Engineer Agent, Designer Agent, and Critic Agent. Each agent is responsible for different aspects of the AR experience creation process, with the Lens Creator Agent focusing on high-level concept generation and planning, the AR Engineer Agent breaking down the concept into specific components and interactions, the Designer Agent handling asset creation and customization, and the Critic Agent evaluating and providing feedback on the generated content.

The system utilizes predefined custom components called Lens Blocks, which encapsulate specific AR functionalities and can be easily combined to create complex AR experiences. These blocks are stored in a Content Management System (CMS), allowing for easy extension and customization of the system's capabilities. This innovative approach solves several key problems associated with conventional AR development methods. By automating many aspects of AR experience creation, the system significantly reduces the need for multidisciplinary expertise, making it possible for non-technical users to create engaging AR content. The multi-agent approach mitigates issues like AI hallucinations and inconsistencies in generated content, ensuring more stable and predictable outputs compared to traditional AI-assisted development tools.

The modular architecture and use of a CMS for storing dynamic details enable easy extension of system capabilities without extensive code changes, fostering a community-based ecosystem for AR development. The system provides real-time generation and preview capabilities, allowing creators to quickly visualize and refine their ideas, significantly reducing development time compared to traditional methods. Automated testing and evaluation mechanisms ensure that generated experiences meet predefined standards of engagement and functionality, maintaining consistent quality across user-generated AR content. The conversational interface and automated processes dramatically lower the barrier to entry for AR experience creation, enabling a wider range of users to participate in AR content development.

By addressing these challenges, the invention democratizes AR experience creation, potentially leading to increased innovation and diversity in AR content. It also significantly reduces the time and resources required for AR development, making it a more efficient and cost-effective process compared to conventional methods. This system represents a significant advancement in the field of AR development, offering a powerful tool that combines the capabilities of artificial intelligence with user-friendly interfaces to revolutionize the way AR experiences are created and shared.

### System Architecture—Multi-Agent LLM-Based System

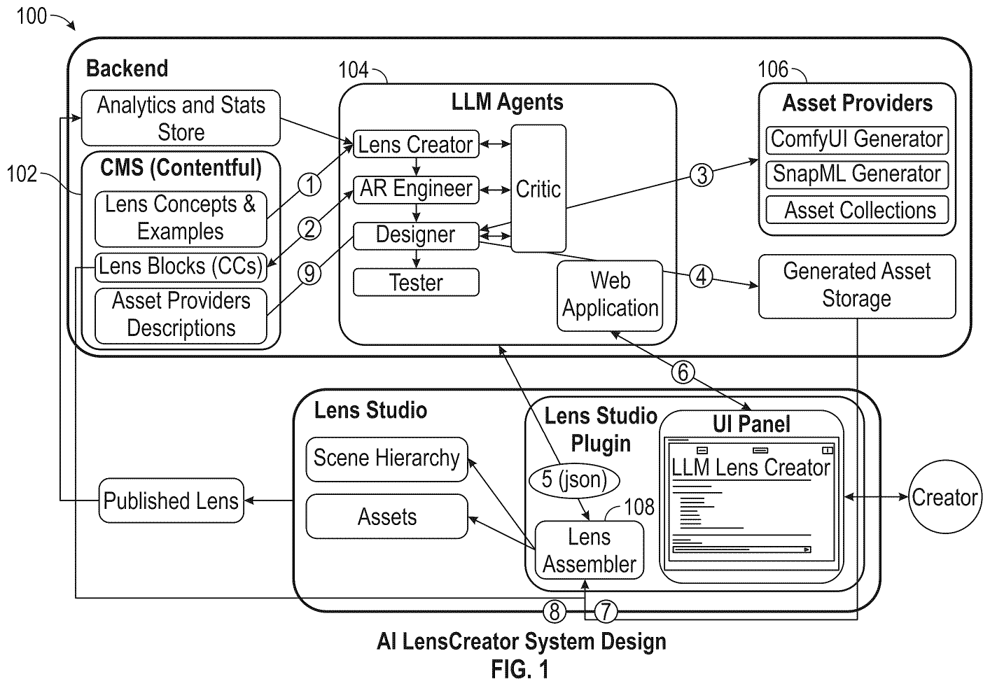

The AI-based AR content creation system design 100, as illustrated in FIG. 1, comprises a sophisticated architecture that integrates multiple components to facilitate the automated creation of augmented reality (AR) experiences. The system is divided into two main sections: the backend (e.g., Backend) and a frontend AR content creation application (e.g., Lens Studio).

The Backend consists of several interconnected components that form the core of the AI-driven AR experience creation process. At the center of the system is the Analytics and Stats Store, which collects and analyzes data on AR experience usage, trends, and performance metrics. This component provides insights that inform the creation process and drive continuous improvement of the system.

One element of the Backend is the Content Management System (CMS) 102, implemented, in one example, using Contentful. The CMS 102 serves as a repository for dynamic content and system configurations, enabling easy extension and customization of the system's capabilities. It houses AR Content (e.g., Lens Concepts & Examples), which provide templates and inspiration for AR experience creation; Lens Blocks (CCs), which are custom components encapsulating specific AR functionalities; and Asset Providers Descriptions, detailing the available asset generation and retrieval services.

The LLM Agents 104 form the intelligent core of the system, comprising multiple specialized agents powered by Large Language Models. These include the AR Content Creator (e.g., Lens Creator), responsible for high-level concept generation and planning; the AR Engineer, which breaks down concepts into specific components and interactions; the Designer, handling asset creation and customization; and the Critic, which evaluates and provides feedback on the generated content. A potential future addition, the Tester agent, is indicated for automated testing of the generated AR experiences.

Asset Providers 106 in the Backend include the ComfyUI Generator and the ML generator (e.g., SnapML Generator) for creating visual assets, as well as Asset Collections for accessing pre-existing assets. The Generated Asset Storage, using Bolt in some example implementations, manages and stores assets created during the AR experience development process.

Another component to the system is the Web Application, which provides a browser-based interface for interacting with the AI-based AR content creation system. This expansion beyond the app-based (e.g., Lens Studio) environment enhances accessibility and usability for a broader range of users.

The app (e.g., Lens Studio) frontend integrates the AI-based AR content creation system with the AR development environment. It includes the app plugin (e.g., Lens Studio Plugin), which facilitates communication between the Backend and Lens Studio. The UI Panel provides an interface within Lens Studio for users to input prompts, view generated content, and make adjustments. The Lens Assembler 108 is a crucial component that constructs the final AR experience based on the “lens recipe” generated by the LLM Agents 104, manipulating the Scene Hierarchy and integrating assets.

The system operates through a series of interactions between these components. The Creator interacts with the system through the UI Panel in Lens Studio or the Web Application. The LLM Agents 104 process the creator's input, utilizing information from the CMS 102 and Analytics store to generate a plan for the AR experience. The Designer agent interacts with Asset Providers 106 to generate or retrieve necessary assets, which are then stored in the Generated Asset Storage. The Lens Assembler 108 receives a “lens recipe” in JSON format from the LLM Agents 104 and uses it to construct the AR experience within Lens Studio. Finally, the completed AR experience can be published and made available for use.

This comprehensive system design enables the creation of AR experiences with minimal user interaction, significantly lowering the barrier to entry for creators. It provides a scalable, extensible platform for AR development that combines the power of artificial intelligence with user-friendly interfaces, revolutionizing the process of AR experience creation and potentially fostering increased innovation and diversity in AR content.

### System Architecture—Component Overview

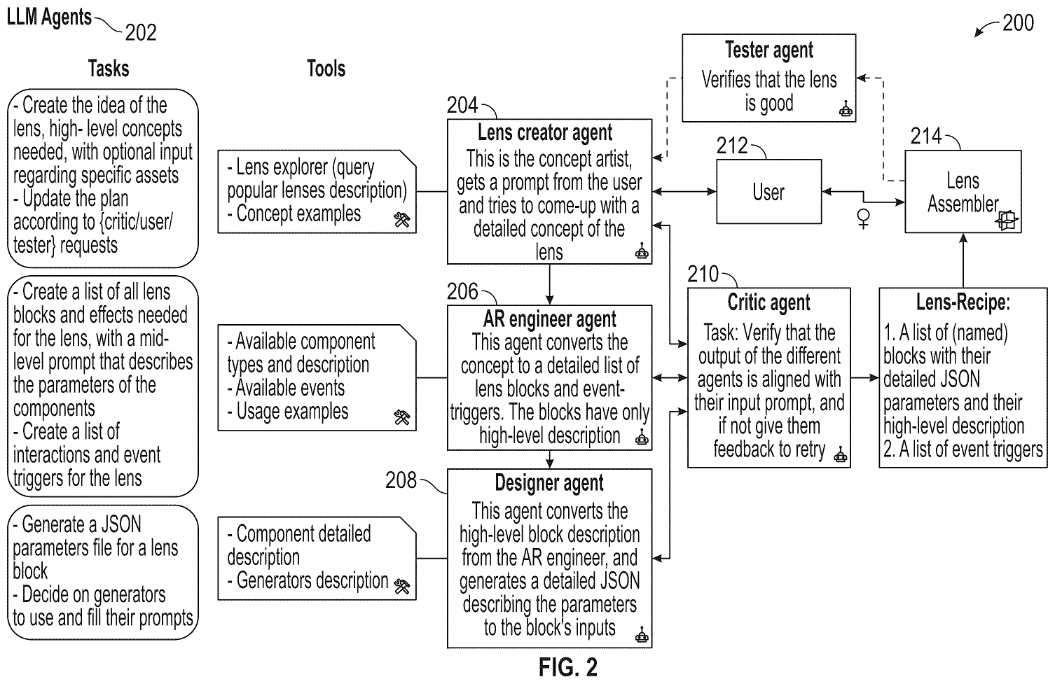

FIG. 2 is a diagram 200 showing the tasks, tools, and interactions of the LLM Agents 202 in the AI-based AR content creation system. This multi-agent architecture comprises several specialized agents, each with distinct roles, tasks, and tools to facilitate the creation of augmented reality (AR) experiences.

The Lens Creator Agent 204 serves as the conceptual artist of the system. Its primary tasks include creating the initial idea for the AR experience, determining high-level concepts needed, and optionally considering specific assets. This agent is also responsible for updating the plan based on feedback from the critic, user, or tester. To accomplish these tasks, the Lens Creator Agent 204 utilizes tools such as a lens explorer to query popular AR experiences descriptions and access concept examples.

The AR Engineer Agent 206 acts as the technical architect, translating high-level concepts into actionable components. Its tasks involve creating a comprehensive list of all lens blocks and effects required for the AR experience, along with a mid-level prompt describing the parameters of these components. Additionally, this agent generates a list of interactions and event triggers for the AR experience. The AR Engineer Agent 206 employs tools that provide information on available component types, their descriptions, available events, and usage examples.

The Designer Agent 208 focuses on the aesthetic and functional details of the AR experience. Its primary tasks are generating JSON parameter files for lens blocks and deciding on appropriate generators to use, including formulating their prompts. This agent relies on tools that offer detailed component descriptions and information about available generators.

The Critic Agent 210 plays a crucial role in quality assurance. Its task is to verify that the output of the different agents aligns with their input prompts. If discrepancies are found, the Critic Agent 210 provides feedback, prompting the other agents to refine their work.

The system also includes a User interface 212, allowing for direct interaction with the LLM Agents 202. This enables iterative refinement of the AR experience based on user input and preferences.

The Lens Assembler 214, while not an agent itself, is a critical component that receives the final output from the agents. It processes the “Lens-Recipe,” which consists of a list of named blocks with their detailed JSON parameters and high-level descriptions, along with a list of event triggers. This recipe serves as the blueprint for constructing the final AR experience.

Lastly, the diagram indicates a Tester Agent, shown with a dashed line, suggesting its status as a planned future implementation. This agent would be responsible for verifying the quality and functionality of the generated AR experience, adding an additional layer of quality control to the system.

This multi-agent approach allows for a sophisticated division of labor, enabling the system to handle complex AR experience creation tasks by breaking them down into specialized roles and leveraging the strengths of each agent.

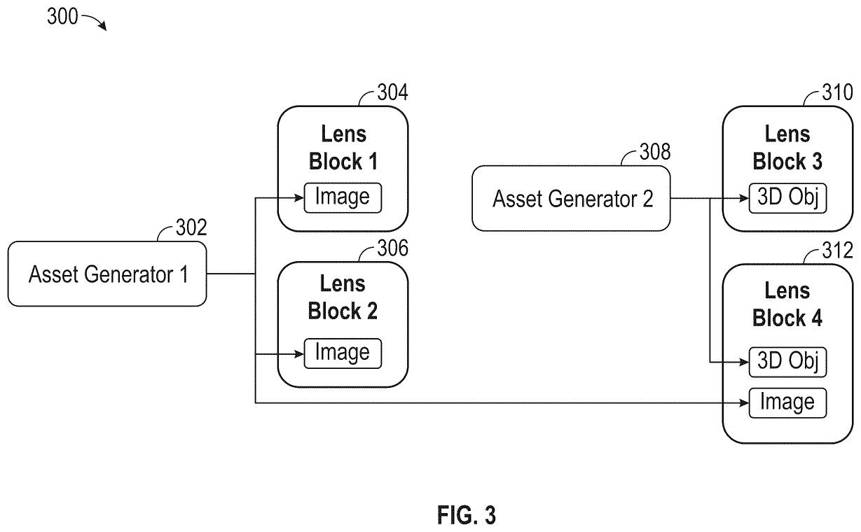

FIG. 3 is a diagram 300 depicting the relationship between Asset Generators and Lens Blocks in the AI-based AR content creation system. This diagram plays a role in demonstrating how the system generates and assembles the components of an augmented reality (AR) experience.

FIG. 3 depicts four Lens Blocks, each representing a distinct functional unit within the AR experience. Lens Blocks are predefined custom components that encapsulate specific AR functionalities and can be easily combined to create complex AR experiences.

In this diagram, we see Lens Block 1 304 and Lens Block 2 306 containing Image components, while Lens Block 3 310 contains a 3D Object component. Lens Block 4 312 is shown to incorporate both a 3D Object and an Image component, illustrating the versatility of these blocks.

The Asset Generators, represented by Asset Generator 1 302 and Asset Generator 2 308, are key elements of the system. These generators are responsible for creating or retrieving the assets needed by the Lens Blocks. Asset generators can be either generative AI tools that create assets on-the-fly or services that retrieve assets from existing collections.

The connections between the Asset Generators and the Lens Blocks demonstrate the flow of asset creation and integration. Asset Generator 1 302 is shown providing assets to Lens Block 1 304 and Lens Block 2 306, while Asset Generator 2 308 supplies assets to Lens Block 3 310 and Lens Block 4 312. This illustrates how different generators can be specialized for creating specific types of assets, such as 2D images or 3D objects.

The modular nature of this system, as depicted in FIG. 3, allows for great flexibility and extensibility. New Lens Blocks and Asset Generators can be added to the system to expand its capabilities, enabling the creation of a wide range of AR experiences. This architecture supports the system's ability to generate AR-ready assets, meaning they are prepared for immediate integration into an AR experience with appropriate semantics and optimized file sizes.

By visualizing the relationship between Lens Blocks and Asset Generators, FIG. 3 demonstrates how the AI AR content creation system can efficiently assemble complex AR experiences from modular components, each enhanced by AI-generated or AI-retrieved assets. This approach enables the system to create diverse and engaging AR experiences while maintaining a streamlined and extensible architecture.

In the context of the AI-based AR content creation system, a block is a modular, self-contained unit of functionality that provides a specific augmented reality (AR) effect or feature. Blocks are the fundamental building blocks of AR experiences created by the system. Each block encapsulates a distinct AR capability, such as adding 3D objects, applying face masks, or generating background images.

Blocks are implemented as custom components with predefined inputs, functions, and events, allowing them to be easily combined and manipulated by the AI system to create complex AR experiences. They are designed to be flexible and reusable, enabling the creation of diverse AR effects without requiring extensive coding or technical expertise from the user.

The system utilizes various types of blocks, each specialized for different aspects of AR creation. These blocks can interact with asset generators to produce or retrieve the necessary visual elements, such as images, 3D models, or textures. The modular nature of blocks allows for easy extension of the system's capabilities by adding new blocks or updating existing ones.

By abstracting complex AR functionalities into manageable blocks, the AI AR content creation system simplifies the process of creating AR experiences, making it accessible to users with limited technical knowledge while maintaining the flexibility to create sophisticated and engaging AR applications.

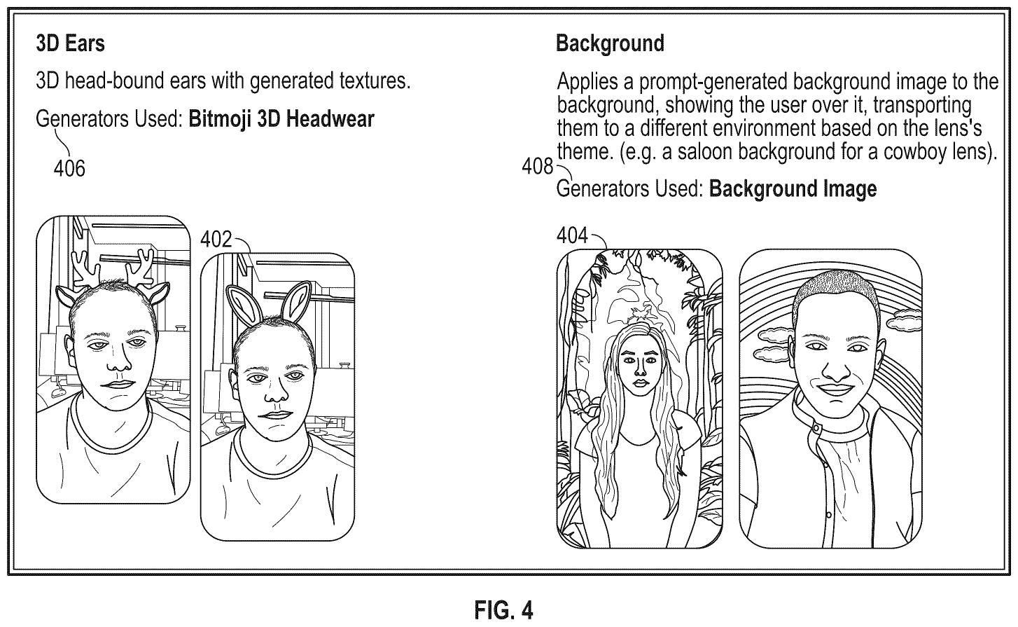

FIG. 4 illustrates the 3D Ears block 402, which adds 3D head-bound cars with generated textures, and the Background block 404, which applies a prompt-generated background image to transport the user to a different environment based on the AR experience theme. The 3D Ears block 402 adds 3D head-bound cars with generated textures to the user's image. This block utilizes the Bitmoji 3D Headwear generator 406 to create realistic, three-dimensional car accessories that are anchored to the user's head. The examples shown in the figure demonstrate how this block can add animal-like cars (such as antlers or rabbit ears) to the user's appearance, enhancing the augmented reality (AR) experience by transforming the user's look in a playful and engaging manner.

The Background block 404 applies a prompt-generated background image to the AR experience, effectively transporting the user to a different environment based on the AR experience theme. This block uses a Background Image generator 408 to create contextually appropriate backdrops. The examples in the figure showcase two distinct background scenarios: a lush, jungle-like environment and a fantastical sky scene with clouds and a rainbow. These backgrounds demonstrate the block's capability to dramatically alter the context of the user's image, enhancing the immersive quality of the AR experience.

Both blocks operate using specialized generators that are part of the Asset Providers component of the AI AR content creation system.

The Bitmoji 3D Headwear generator 406 for the 3D Ears block 402 likely utilizes 3D modeling techniques and texture generation to create realistic car accessories that can be seamlessly integrated with the user's image. The Background Image generator 408, on the other hand, probably employs advanced image generation models, possibly based on large language models and image generation techniques, to create diverse and contextually relevant background images based on text prompts.

These blocks exemplify the modular and flexible nature of the AI AR content creation system, allowing for the creation of complex AR experiences by combining different functional units, each enhanced by AI-generated assets. The system's ability to generate these AR-ready assets on-demand, with appropriate semantics and optimized file sizes, enables the rapid creation of diverse and engaging AR experiences without requiring extensive manual design work.

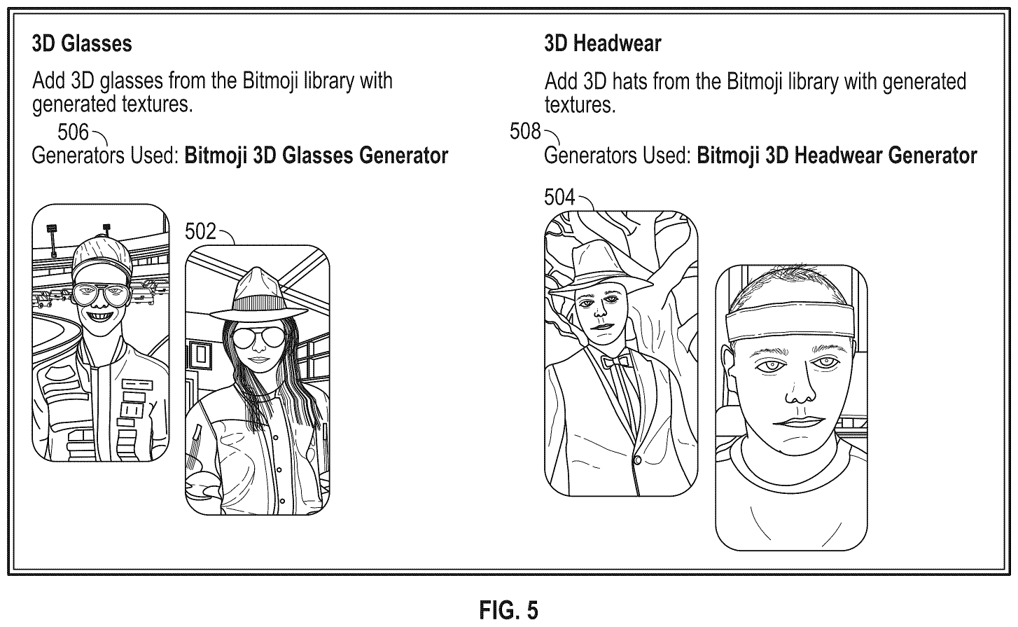

FIG. 5 depicts the 3D Glasses block 502, which adds 3D glasses from the Bitmoji library with generated textures, and the 3D Headwear block 504, which adds 3D hats from the Bitmoji library with generated textures. FIG. 5 illustrates two key blocks in the AI AR content creation system: the 3D Glasses block 502 and the 3D Headwear block 504. The 3D Glasses block 502 adds 3D glasses from the Bitmoji library with generated textures to the user's image. This block utilizes the Bitmoji 3D Glasses Generator 506 to create realistic, three-dimensional glasses that are anchored to the user's face. The examples shown in the figure demonstrate how this block can add various styles of glasses, such as sporty sunglasses or aviator-style glasses, enhancing the augmented reality (AR) experience by transforming the user's appearance in a realistic manner.

The 3D Headwear block 504 adds 3D hats from the Bitmoji library with generated textures to the user's image. This block uses the Bitmoji 3D Headwear Generator 508 to create diverse and contextually appropriate headwear. The examples in the figure showcase different types of headwear, including a cowboy hat and a sports cap, demonstrating the block's capability to add thematic elements to the user's appearance, further enhancing the immersive quality of the AR experience.

Both blocks operate using specialized generators that are part of the Asset Providers component of the AI AR content creation system.

The Bitmoji 3D Glasses Generator 506 and Bitmoji 3D Headwear Generator 508 likely utilize 3D modeling techniques and texture generation to create realistic accessories that can be seamlessly integrated with the user's image. These generators allow for the creation of diverse and contextually relevant 3D objects based on the theme or requirements of the AR experience. These blocks exemplify the modular and flexible nature of the AI AR content creation system, allowing for the creation of complex AR experiences by combining different functional units, each enhanced by AI-generated assets.

The system's ability to generate these AR-ready assets on-demand, with appropriate semantics and optimized file sizes, enables the rapid creation of diverse and engaging AR experiences without requiring extensive manual design work.

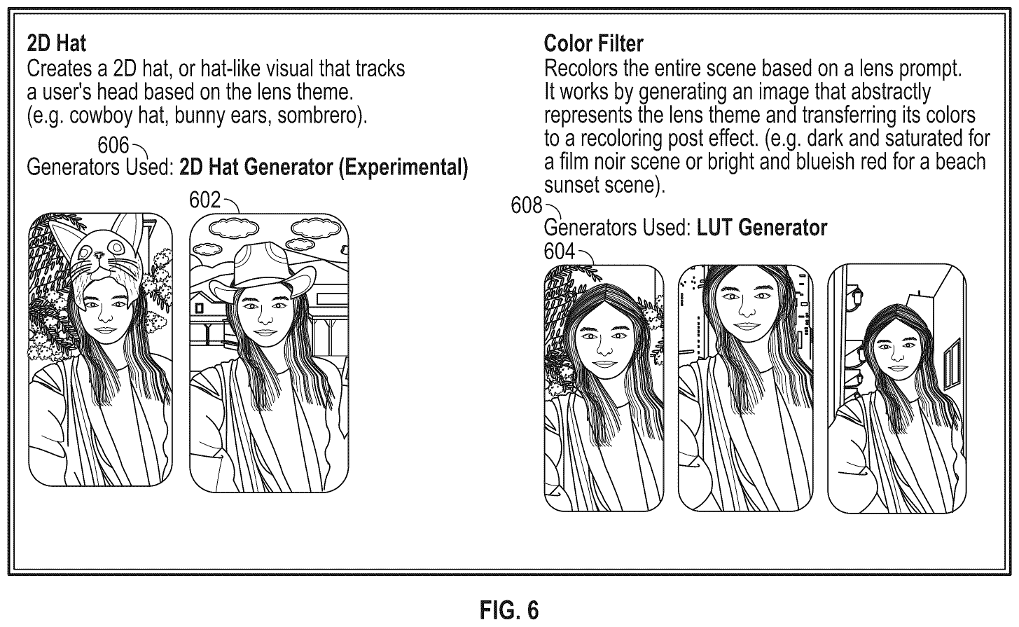

FIG. 6 shows the 2D Hat block 602, which creates a 2D hat or hat-like visual that tracks a user's head based on the AR experience theme, and the Color Filter block 604, which recolors the entire scene based on a prompt by generating an image that abstractly represents the AR experience theme. FIG. 6 illustrates two key blocks in the AI AR content creation system: the 2D Hat block 602 and the Color Filter block 604. The 2D Hat block 602 creates a 2D hat or hat-like visual that tracks a user's head based on the AR experience theme. This block utilizes an experimental 2D Hat Generator 606 to create and position various hat styles on the user's head. The examples shown in the figure demonstrate how this block can add different types of hats, such as animal-themed headwear (e.g., bunny ears) and a cowboy hat, enhancing the augmented reality (AR) experience by adding thematic elements to the user's appearance.

The Color Filter block 604 recolors the entire scene based on a prompt provided for the AR experience. It operates by generating an image that abstractly represents the AR experience theme and then transferring its colors to create a recoloring post-effect. This block uses a LUT (Look-Up Table) Generator 608 to achieve its effects. The examples in the figure showcase different color filters applied to the same base image, demonstrating how this block can dramatically alter the mood and atmosphere of the AR experience. For instance, it can create effects such as a dark and saturated look for a film noir scene or a bright and bluish-red tint for a beach sunset scene.

Both blocks exemplify the modular and flexible nature of the AI AR content creation system, allowing for the creation of complex AR experiences by combining different functional units, each enhanced by AI-generated assets. The system's ability to generate these AR-ready assets on-demand, with appropriate semantics and optimized file sizes, enables the rapid creation of diverse and engaging AR experiences without requiring extensive manual design work.

The 2D Hat block and Color Filter block can be used in conjunction with other blocks to create more complex and immersive AR experiences. For example, the 2D Hat block could be combined with facial recognition features to ensure proper placement and tracking of the hat on the user's head, while the Color Filter block could be used in tandem with background replacement or particle effects to create a cohesive themed environment.

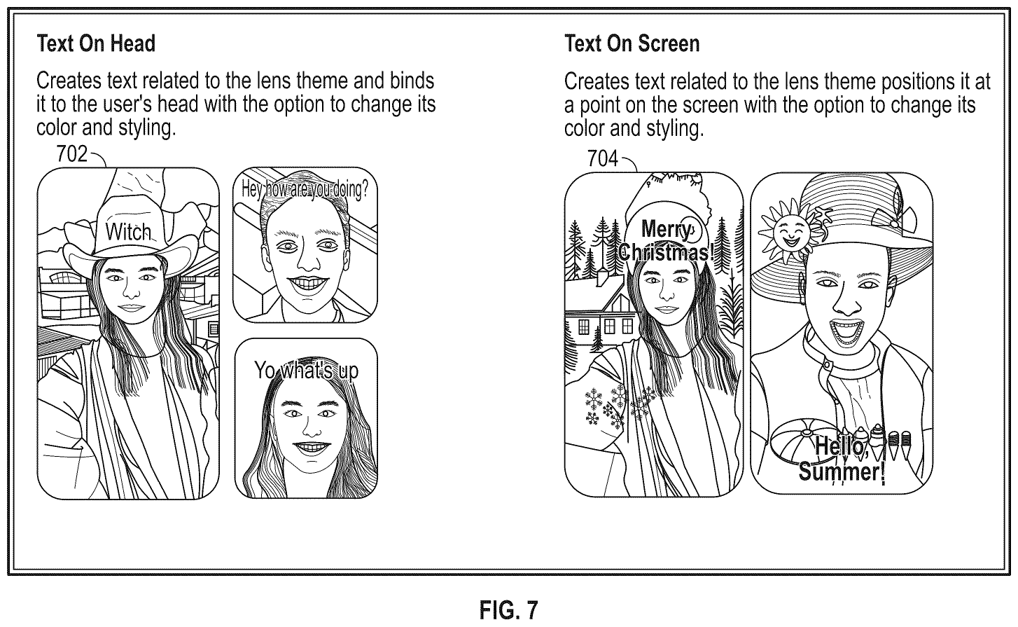

FIG. 7 illustrates the Text On Head block 702, which creates theme-related text bound to the user's head, and the Text On Screen block 704, which positions theme-related text at a point on the screen. FIG. 7 illustrates two key blocks in the AI AR content creation system: the Text On Head block 702 and the Text On Screen block 704. The Text On Head block 702 creates text related to the AR experience theme and binds it to the user's head with the option to change its color and styling. This block allows for dynamic, personalized text elements that move with the user's head movements, enhancing the immersive quality of the AR experience. The examples shown in the figure demonstrate various applications of this block, such as adding the word “witch” above a user's head in a Halloween-themed AR experience, or displaying conversational text like “Hey how are you doing?” and “Yo what's up” that follows the user's head movements.

The Text On Screen block 704 creates text related to the AR experience theme and positions it at a specific point on the screen, also with the option to change its color and styling. This block enables the addition of static text elements to the AR experience, which can be used for captions, titles, or informational text that remains fixed on the screen regardless of user movement. The examples in the figure showcase different uses of this block, including seasonal greetings like “Merry Christmas!” with accompanying snowflake graphics, and a cheerful “Hello Summer!” message with a sun icon, demonstrating how this block can be used to set the mood or provide context for the AR experience.

Both blocks exemplify the modular and flexible nature of the AI AR content creation system, allowing for the creation of complex AR experiences by combining different functional units. These text-based blocks can be used in conjunction with other visual effects to create more engaging and interactive AR experiences, such as combining the Text On Head block with facial recognition features to trigger text changes based on expressions, or using the Text On Screen block to provide instructions or narrative elements in a themed AR experience.

The ability to easily add and customize text elements in AR experiences enhances the system's capability to create diverse and engaging content without requiring extensive manual design work, aligning with the AI AR content creation's goal of democratizing AR experience creation.

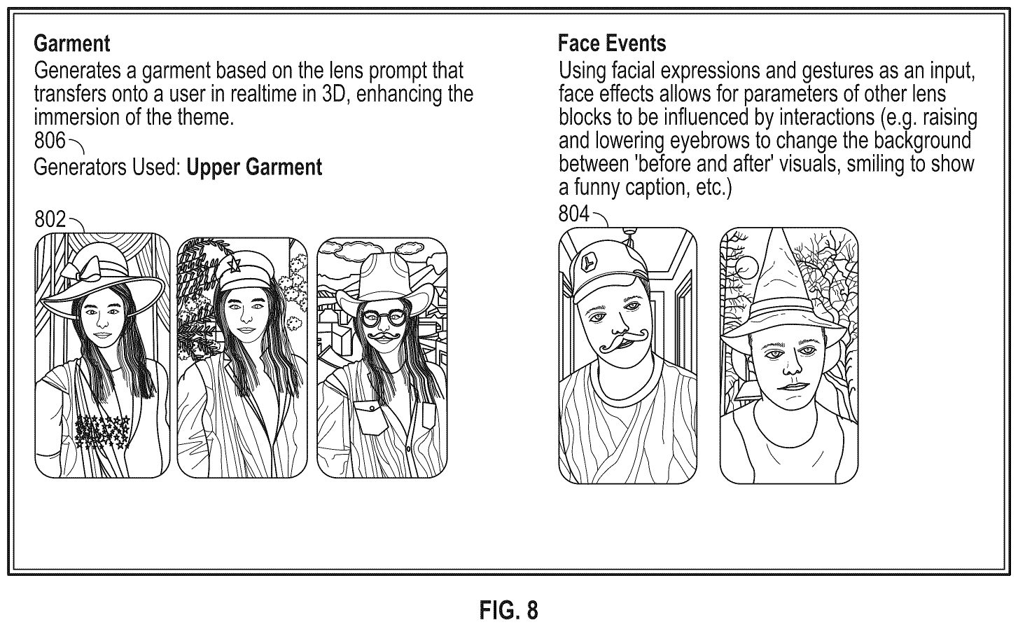

FIG. 8 depicts the Garment block 802, which generates a garment based on the AR experience prompt and transfers it onto the user in real-time, and the Face Events block 804, which uses facial expressions as input to influence other block parameters. FIG. 8 illustrates two key blocks in the AI AR content creation system: the Garment block 802 and the Face Events block 804. The Garment block 802 generates a garment based on the AR experience prompt and transfers it onto the user in real-time, enhancing the immersion of the theme. This block utilizes the Upper Garment generator 806 to create realistic, three-dimensional clothing that is seamlessly integrated with the user's image. The examples shown in the figure demonstrate how this block can add various styles of clothing, such as formal attire, casual wear, and themed costumes, effectively transforming the user's appearance to match the AR experience theme.

The Face Events block 804 uses facial expressions and gestures as input to influence parameters of other lens blocks. This block enables interactive and dynamic AR experiences by allowing facial movements to trigger changes in the AR environment. For example, it can enable raising and lowering eyebrows to change the background between ‘before and after’ visuals, or smiling to show a funny caption. The examples in the figure showcase different facial expressions and their potential effects, demonstrating the block's capability to add an interactive layer to the AR experience.

Both blocks exemplify the modular and flexible nature of the AI AR content creation system, allowing for the creation of complex AR experiences by combining different functional units, each enhanced by AI-generated assets. The Garment block 802 showcases the system's ability to generate and apply complex 3D assets in real-time, while the Face Events block 804 demonstrates the system's capacity for creating interactive and responsive AR experiences. These blocks can be used in conjunction with other blocks to create more immersive and engaging AR experiences. For instance, the Garment block 802 could be combined with background replacement to create a fully themed environment, while the Face Events block 804 could be used to trigger changes in multiple other blocks, creating a highly interactive and dynamic AR experience.

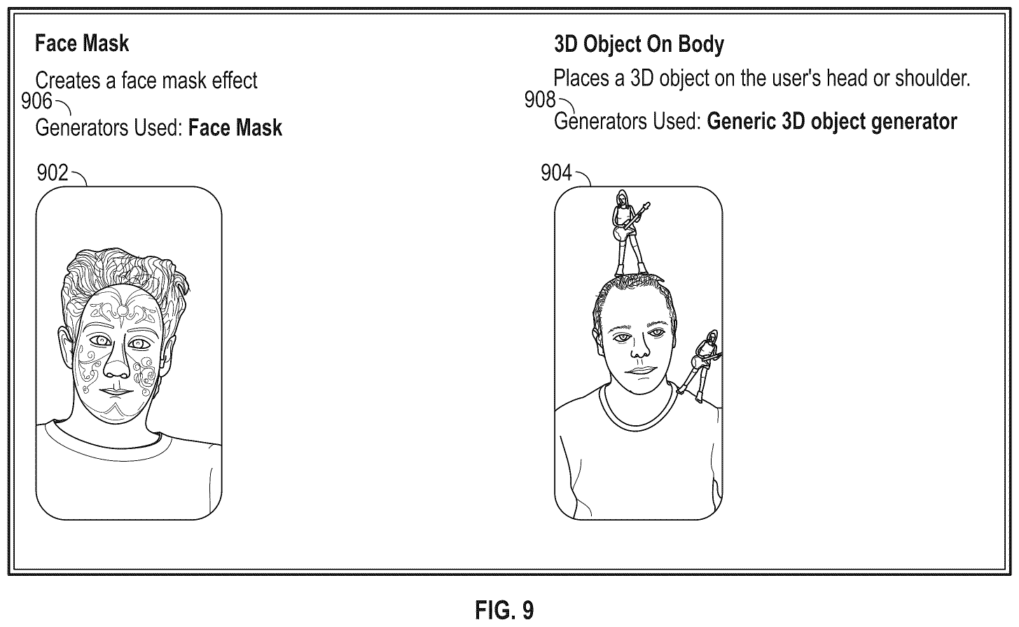

FIG. 9 shows the Face Mask block 902, which creates a face mask effect, and the 3D Object On Body block 904, which places a 3D object on the user's head or shoulder. FIG. 9 illustrates two key blocks in the AI AR content creation system: the Face Mask block 902 and the 3D Object On Body block 904. The Face Mask block 902 creates a face mask effect using the Face Mask generator 906. This block allows for the application of complex visual effects directly onto the user's face, transforming their appearance in real-time. The example shown in the figure demonstrates a golden, metallic-looking face mask with intricate patterns and glowing blue eyes, showcasing the block's capability to create dramatic and fantastical facial transformations.

The 3D Object On Body block 904 places a 3D object on the user's head or shoulder using the Generic 3D object generator 908. This block enables the addition of three-dimensional elements to the augmented reality (AR) experience, enhancing the visual complexity and interactivity of the AR application. The example in the figure shows small 3D figures placed on the user's head and shoulder, demonstrating how this block can add whimsical or themed elements to the user's appearance.

Both blocks exemplify the modular and flexible nature of the AI AR content creation system, allowing for the creation of complex AR experiences by combining different functional units, each enhanced by AI-generated assets. The Face Mask block 902 showcases the system's ability to generate and apply intricate facial effects, while the 3D Object On Body block 904 demonstrates the system's capacity for integrating three-dimensional elements into the AR experience.

These blocks can be used in conjunction with other blocks to create more immersive and engaging AR experiences. For instance, the Face Mask block 902 could be combined with the Color Filter block to create a cohesive themed look, while the 3D Object On Body block 904 could be used with the Face Events block to create interactive 3D elements that respond to the user's facial expressions.

The use of specialized generators for each block, such as the Face Mask generator 906 and the Generic 3D object generator 908, allows for the creation of high-quality, context-appropriate assets that can be seamlessly integrated into the AR experience. This approach enables the rapid creation of diverse and engaging AR experiences without requiring extensive manual design work, aligning with the AI AR content creation's goal of democratizing AR experience creation.

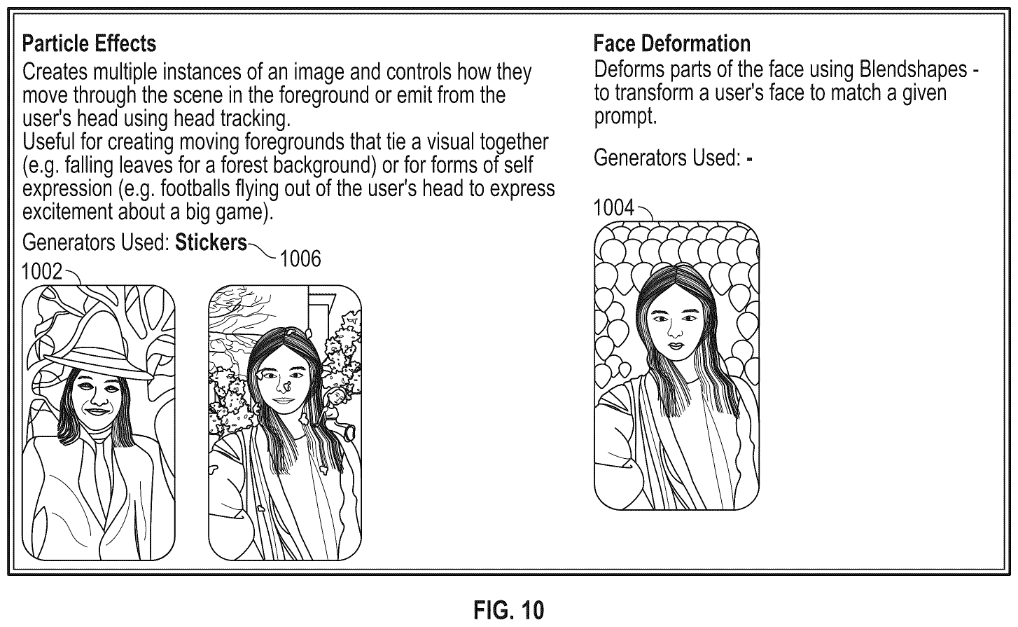

FIG. 10 illustrates the Particle Effects block 1002, which creates multiple instances of an image moving through the scene, and the Face Deformation block 1004, which transforms the user's face using Blendshapes. FIG. 10 illustrates two key blocks in the AI AR content creation system: the Particle Effects block 1002 and the Face Deformation block 1004. The Particle Effects block 1002 creates multiple instances of an image and controls how they move through the scene in the foreground or emit from the user's head using head tracking.

This block utilizes the Stickers generator 1006 to create the particle images. The examples shown in the figure demonstrate two applications of this block: one creating a spooky atmosphere with floating particles around a user in a witch-themed AR experience, and another showing cherry blossoms falling in a spring-themed scene. This block is particularly useful for creating moving foregrounds that tie a visual together (e.g., falling leaves for a forest background) or for forms of self-expression (e.g., footballs flying out of the user's head to express excitement about a big game).

The Face Deformation block 1004 deforms parts of the face using Blendshapes to transform a user's face to match a given prompt. Unlike many other blocks, this one does not use a specific generator, as indicated by the lack of a generator listed in the figure. The example in the figure shows a user's face surrounded by colorful balloons, suggesting that this block can be used in conjunction with other effects to create more complex AR experiences. The Face Deformation block 1004 allows for subtle or dramatic changes to facial features, enabling a wide range of creative possibilities in AR applications.

Both blocks exemplify the modular and flexible nature of the AI AR content creation system, allowing for the creation of complex AR experiences by combining different functional units. The Particle Effects block 1002 showcases the system's ability to generate dynamic, animated elements that enhance the immersive quality of the AR experience, while the Face Deformation block 1004 demonstrates the capability to alter the user's appearance in real-time, creating engaging and often humorous effects.

These blocks can be used in combination with other blocks to create more sophisticated AR experiences. For instance, the Particle Effects block 1002 could be combined with the Background block to create a fully immersive themed environment, while the Face Deformation block 1004 could be used with the Face Events block to create interactive facial transformations that respond to the user's expressions.

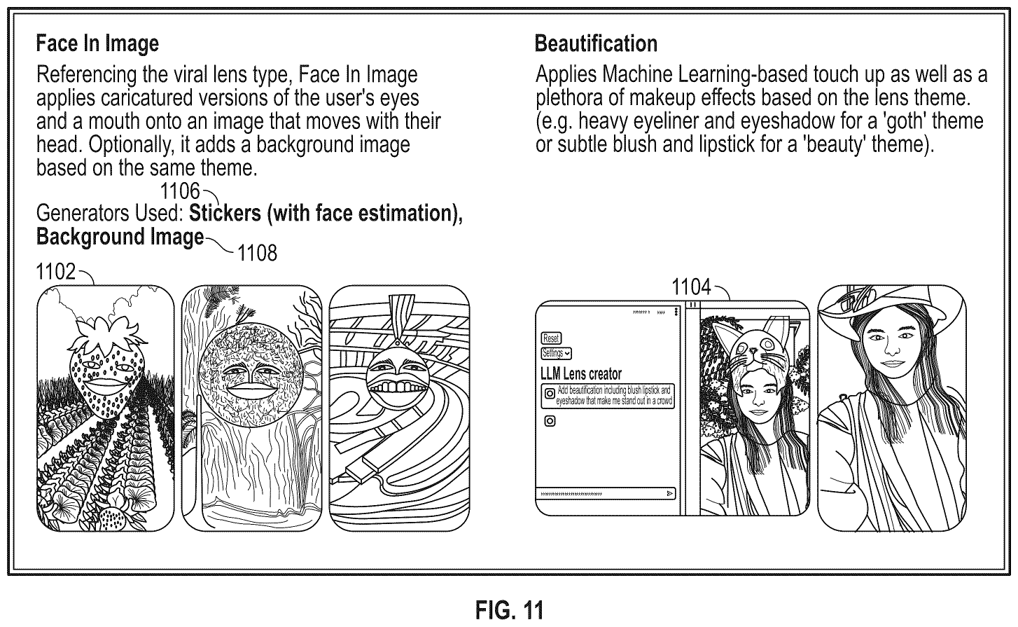

FIG. 11 depicts the Face In Image block 1102, which applies caricatured versions of the user's eyes and mouth onto an image that moves with their head, and the Beautification block 1104, which applies machine learning-based touch-up and makeup effects. FIG. 11 illustrates two key blocks in the AI AR content creation system: the Face In Image block 1102 and the Beautification block 1104. The Face In Image block 1102 references a viral AR experience type, applying caricatured versions of the user's eyes and mouth onto an image that moves with their head.

This block utilizes two generators: Stickers (with face estimation) 1106 and Background Image 1108. The examples shown in the figure demonstrate various applications of this block, such as placing the user's facial features on a strawberry in a field, a snowball in a winter scene, and a gold medal in a stadium. This block enhances the immersive and playful nature of the AR experience by allowing users to become part of themed images or objects.

The Beautification block 1104 applies Machine Learning-based touch-up effects as well as a plethora of makeup effects based on the AR experience theme. This block does not use a specific generator, as indicated by the lack of a generator listed in the figure. The examples showcase different applications of this block, including adding heavy eyeliner and eyeshadow for a ‘goth’ theme, or subtle blush and lipstick for a ‘beauty’ theme. The figure displays a user interface for the LLM Lens creator, suggesting that these beautification effects can be customized through a conversational interface.

Both blocks exemplify the modular and flexible nature of the AI AR content creation system, allowing for the creation of complex AR experiences by combining different functional units.

The Face In Image block 1102 showcases the system's ability to generate creative and engaging visual transformations, while the Beautification block 1104 demonstrates the capability to enhance the user's appearance in real-time, creating sophisticated and theme-appropriate makeup effects.

These blocks can be used in combination with other blocks to create more sophisticated AR experiences. For instance, the Face In Image block 1102 could be combined with the Background block to create a fully immersive themed environment, while the Beautification block 1104 could be used with the Face Events block to create interactive makeup transformations that respond to the user's expressions.

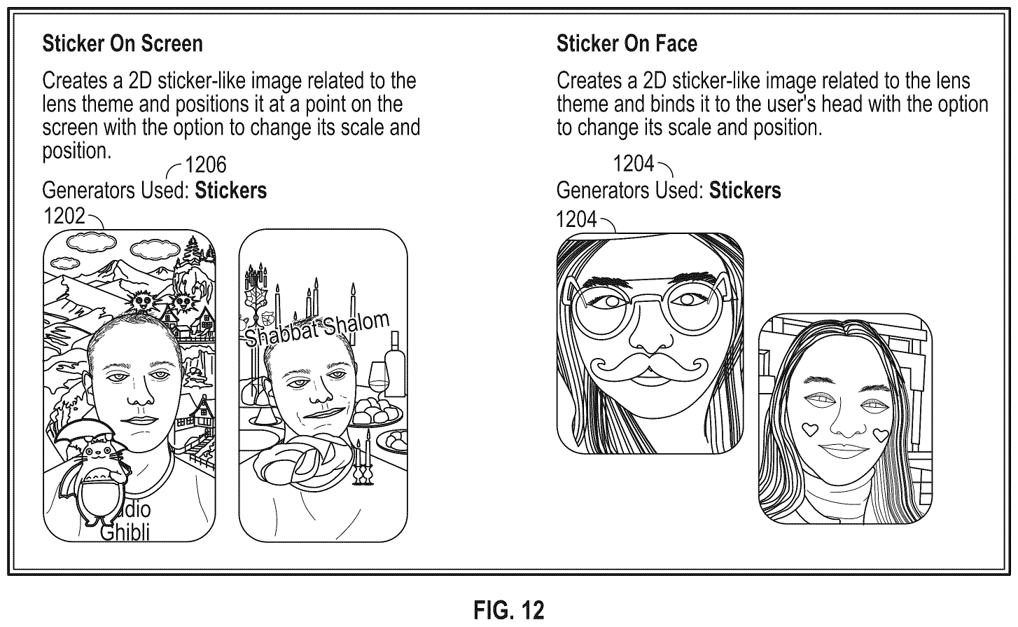

FIG. 12 shows the Sticker On Screen block 1202, which creates a 2D sticker-like image positioned on the screen, and the Sticker On Face block 1204, which creates a 2D sticker-like image bound to the user's head. FIG. 12 illustrates two key blocks in the AI AR content creation system: the Sticker On Screen block 1202 and the Sticker On Face block 1204. The Sticker On Screen block 1202 creates a 2D sticker-like image related to the AR experience theme and positions it at a point on the screen with the option to change its scale and position.

This block utilizes the Stickers generator 1206 to create and place various themed stickers on the screen. The examples shown in the figure demonstrate different applications of this block, such as adding cartoon characters and text overlays to create themed experiences. One image shows a nature scene with cartoon eyes and a character added, while another displays a “Shabbat Shalom” message over a festive dinner scene.

The Sticker On Face block 1204 creates a 2D sticker-like image related to the AR experience theme and binds it to the user's head with the option to change its scale and position. This block also uses the Stickers generator 1206 to create facial decorations or accessories. The examples in the figure showcase various face stickers, including a mustache overlay and heart-shaped check decorations, demonstrating how this block can add playful or themed elements directly to the user's face.

Both blocks exemplify the modular and flexible nature of the AI AR content creation system, allowing for the creation of complex AR experiences by combining different functional units, each enhanced by AI-generated assets. The Sticker On Screen 1202 and Sticker On Face 1204 blocks showcase the system's ability to generate and apply 2D graphical elements in real-time, enhancing the visual appeal and thematic consistency of the AR experience.

These blocks can be used in conjunction with other blocks to create more sophisticated AR experiences. For instance, the Sticker On Screen block 1202 could be combined with the Background block to create a fully themed environment, while the Sticker On Face block 1204 could be used with the Face Events block to create interactive facial decorations that respond to the user's expressions.

The use of the Stickers generator 1206 for both blocks allows for the creation of diverse and contextually appropriate assets that can be seamlessly integrated into the AR experience.

This approach enables the rapid creation of engaging AR experiences without requiring extensive manual design work, aligning with the AI AR content creation's goal of democratizing AR experience creation.

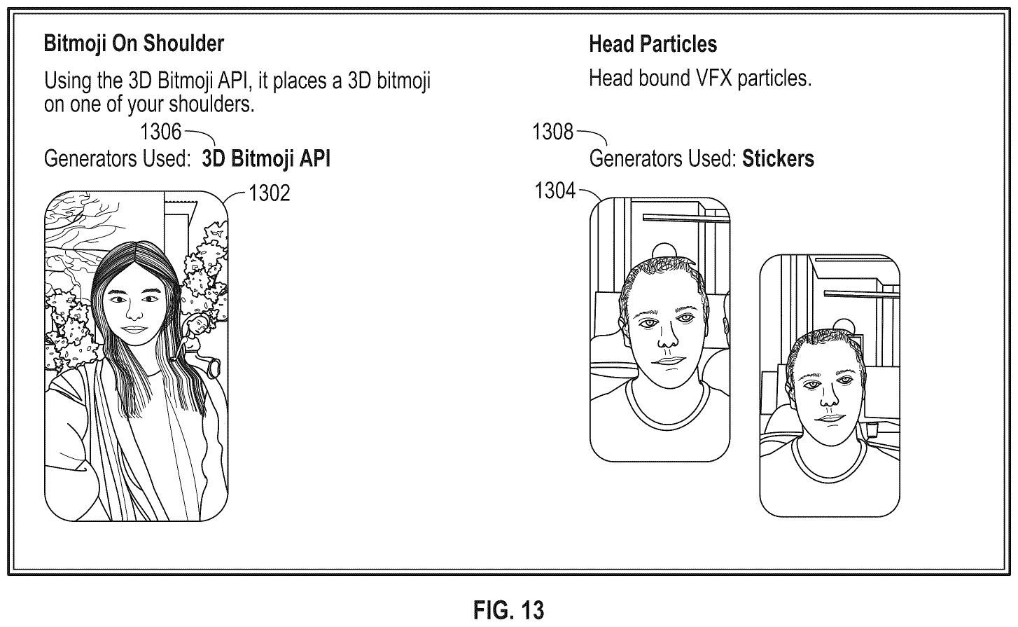

FIG. 13 illustrates the Bitmoji On Shoulder block 1302, which places a 3D Bitmoji on the user's shoulder, and the Head Particles block 1304, which creates head-bound VFX particles. FIG. 13 illustrates two key blocks in the AI AR content creation system: the Bitmoji On Shoulder block 1302 and the Head Particles block 1304. The Bitmoji On Shoulder block 1302 uses the 3D Bitmoji API 1306 to place a 3D Bitmoji on one of the user's shoulders. This block does not use any specific generator, as indicated by the lack of a generator listed in the figure. The example shown demonstrates how this block can add a personalized 3D character to the user's image, enhancing the augmented reality (AR) experience by adding a companion or avatar to the scene.

The Head Particles block 1304 creates head-bound VFX (Visual Effects) particles. This block utilizes the Stickers generator 1308 to create and animate particle effects that are anchored to the user's head. The examples in the figure showcase different applications of this block, demonstrating how it can add dynamic visual elements that move with the user's head movements, such as sparkles, bubbles, or other themed particles.

Both blocks exemplify the modular and flexible nature of the AI AR content creation system, allowing for the creation of complex AR experiences by combining different functional units, each enhanced by AI-generated assets. The Bitmoji On Shoulder block 1302 showcases the system's ability to integrate pre-existing 3D assets (Bitmojis) into the AR experience, while the Head Particles block 1304 demonstrates the capability to add dynamic, animated elements that enhance the visual appeal and interactivity of the AR application.

These blocks can be used in conjunction with other blocks to create more sophisticated AR experiences. For instance, the Bitmoji On Shoulder block 1302 could be combined with the Face Events block to create interactive scenarios where the Bitmoji reacts to the user's facial expressions. Similarly, the Head Particles block 1304 could be used with the Color Filter block to create themed particle effects that match the overall color scheme of the AR experience. The use of the Stickers generator 1308 for the Head Particles block 1304 allows for the creation of diverse and contextually appropriate particle effects that can be seamlessly integrated into the AR experience. This approach enables the rapid creation of engaging AR experiences without requiring extensive manual design work, aligning with the AI AR content creation's goal of democratizing AR experience creation.

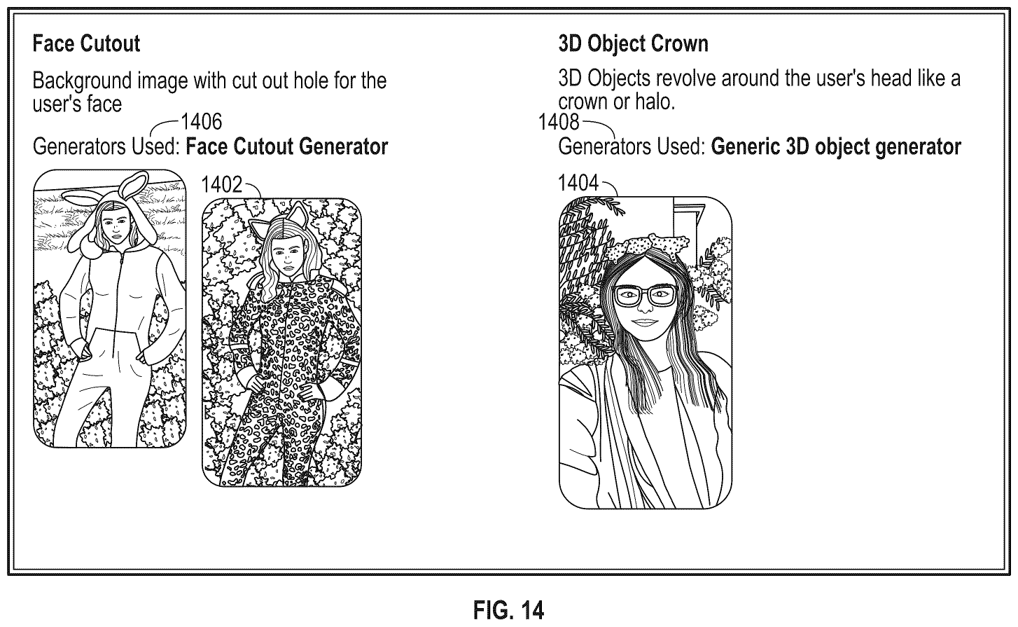

FIG. 14 depicts the Face Cutout block 1402, which creates a background image with a cut-out hole for the user's face, and the 3D Object Crown block 1404, which makes 3D objects revolve around the user's head. FIG. 14 illustrates two key blocks in the AI AR content creation system: the Face Cutout block 1402 and the 3D Object Crown block 1404. The Face Cutout block 1402 creates a background image with a cut-out hole for the user's face.

This block utilizes the Face Cutout Generator 1406 to produce themed backgrounds that incorporate the user's face in a creative way. The examples shown in the figure demonstrate various applications of this block, such as placing the user's face in animal-themed full-body costumes. One image shows a user's face integrated into a bunny costume in a field of flowers, while another displays a user's face in a leopard-print outfit, showcasing how this block can create immersive and playful augmented reality (AR) experiences.

The 3D Object Crown block 1404 makes 3D objects revolve around the user's head like a crown or halo. This block employs the Generic 3D object generator 1408 to create and position 3D elements that orbit the user's head. The example in the figure shows a user wearing sunglasses with what appears to be flower-like objects revolving around their head, demonstrating how this block can add dynamic, three-dimensional elements to enhance the visual appeal and interactivity of the AR application.

Both blocks exemplify the modular and flexible nature of the AI AR content creation system, allowing for the creation of complex AR experiences by combining different functional units, each enhanced by AI-generated assets. The Face Cutout block 1402 showcases the system's ability to seamlessly integrate user features into generated backgrounds, while the 3D Object Crown block 1404 demonstrates the capability to add dynamic, animated 3D elements that enhance the immersive quality of the AR experience. These blocks can be used in conjunction with other blocks to create more sophisticated AR experiences. For instance, the Face Cutout block 1402 could be combined with the Color Filter block to create fully themed environments, while the 3D Object Crown block 1404 could be used with the Face Events block to create interactive 3D elements that respond to the user's facial expressions. The use of specialized generators for each block, such as the Face Cutout Generator 1406 and the Generic 3D object generator 1408, allows for the creation of high-quality, context-appropriate assets that can be seamlessly integrated into the AR experience.

This approach enables the rapid creation of diverse and engaging AR experiences without requiring extensive manual design work, aligning with the AI AR content creation's goal of democratizing AR experience creation.

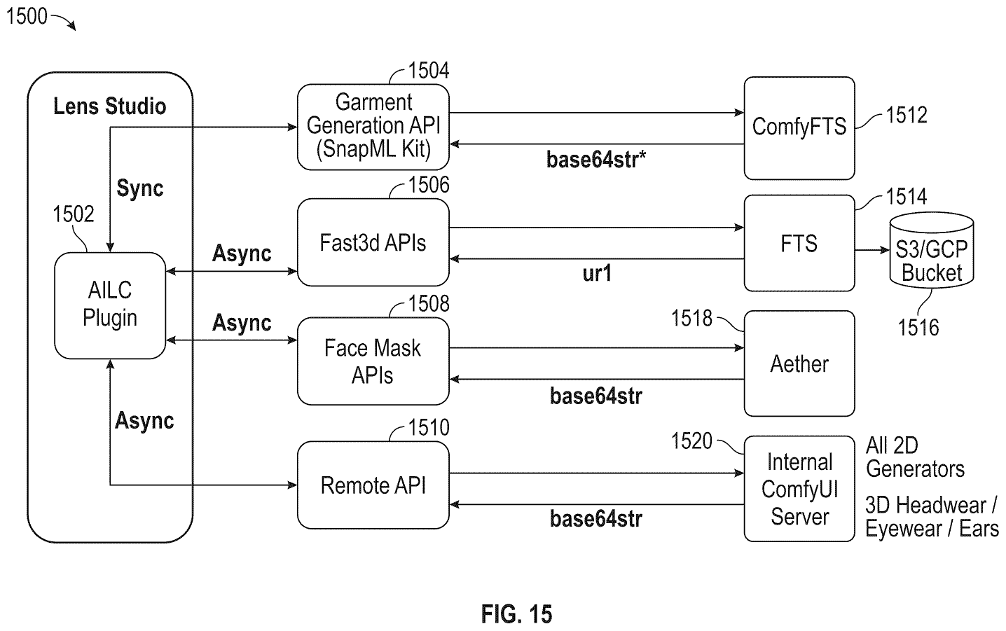

FIG. 15 is a diagram illustrating the integration of various APIs and services with the AILC Plugin in Lens Studio. FIG. 15 illustrates the architecture and data flow of the AI AR content creation (AILC) Plugin system, which is a key component of the larger AI AR content creation system. This diagram showcases how the AILC Plugin interacts with various backend services to generate and manipulate assets for augmented reality (AR) experiences.

The AILC Plugin, integrated within Lens Studio, serves as the central hub for communication between the user interface and the backend services. It manages both synchronous and asynchronous calls to different APIs and services, enabling the creation of diverse AR assets and effects. The plugin communicates with four main components: the Garment Generation API, Fast3d APIs, Face Mask APIs, and a Remote API.

The Garment Generation API, part of the SnapML Kit, handles the creation of virtual garments for AR try-on experiences. It operates synchronously with the AILC Plugin, using base64 string encoding for data transfer to and from the ComfyFTS service. This allows for real-time generation and application of virtual clothing to the user's image.

The Fast3d APIs are responsible for generating 3D assets such as headwear and eyewear. These APIs function asynchronously with the AILC Plugin and communicate with the FTS (File Transfer Service) using URLs. The FTS manages the transfer and storage of these 3D assets, interfacing with an S3/GCP Bucket for cloud storage.

The Face Mask APIs generate face masks and other facial AR effects. They operate asynchronously with the AILC Plugin and use base64 string encoding for data transfer with the Aether service. This allows for the creation of complex facial overlays and effects that can be applied in real-time to the user's face.

The Remote API handles communication with the Internal ComfyUI server, which is responsible for generating various 2D and 3D assets, including headwear, eyewear, and cars. It functions asynchronously and uses base64 string encoding for data transfer. This API enables the creation of a wide range of visual elements that can be incorporated into the AR experience.

The backend services include ComfyFTS for garment generation tasks, FTS for 3D asset transfer and storage, Aether for face mask generation, and the Internal ComfyUI server for handling the generation of various 2D and 3D assets. These services work in concert to provide a comprehensive suite of asset generation capabilities for the AI AR content creation system.

This architecture allows for efficient asset generation and management, enabling the AI AR content creation system to create complex AR experiences with minimal user input. The use of both synchronous and asynchronous communication methods ensures responsive user interaction while allowing for potentially time-consuming asset generation processes. The system's modular design facilitates easy integration of new asset generation capabilities and services, supporting the extensible nature of the AI AR content creation platform. This aligns with the goal of providing a flexible and powerful tool for creating diverse AR experiences without requiring extensive technical knowledge from the end-user.

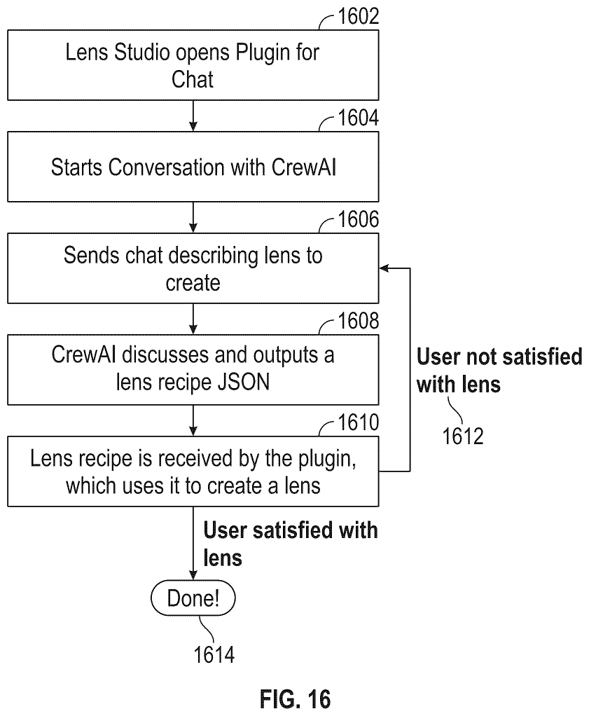

The diagram in FIG. 16 depicts a sequential process for creating an augmented reality (AR) application, referred to as a “lens” in the system. The process begins when Lens Studio opens the Plugin for Chat 1602, initiating a conversation with the CrewAI system 1604. The user then sends a chat message describing the desired AR application to create 1606.

Upon receiving the user's input, the CrewAI system engages in an internal discussion process to generate a “lens recipe” in JSON format 1608. This recipe is a detailed specification for creating the AR application based on the user's description. The lens recipe is then received by the plugin, which uses it to create the actual AR application within Lens Studio 1610.

The system incorporates a feedback loop 1612, allowing for iterative refinement of the AR application. If the user is not satisfied with the generated lens, they can provide additional input, and the process cycles back to the CrewAI discussion stage. This iteration continues until the user is satisfied with the result, at which point the process is complete 1614.

This workflow fits into the larger AI AR content creation system by serving as the primary interface between the user's creative intent and the technical implementation of the AR application. It leverages the natural language processing capabilities of the CrewAI system to translate user descriptions into actionable specifications, while also allowing for user feedback and iterative improvement.

The process illustrated in FIG. 16 aligns with the system's goal of democratizing AR application creation by providing a user-friendly, conversation-based interface for generating complex AR experiences. It encapsulates the technical complexities of AR application development within the CrewAI system and the Lens Studio plugin, allowing users to focus on their creative vision rather than technical implementation details.

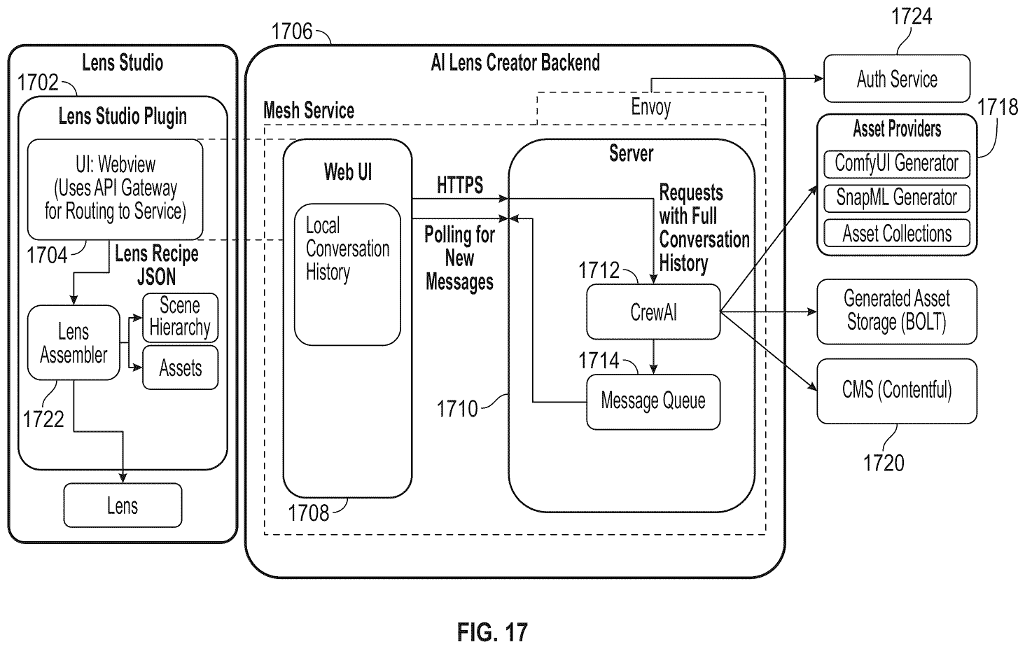

FIG. 17 is a system architecture diagram detailing the backend components and their interactions with Lens Studio. FIG. 17 illustrates a design for the AI Lens Creator Backend implemented as a Mesh Service. This architecture showcases the integration between the Lens Studio Plugin 1702 and various backend components, facilitating the creation of augmented reality (AR) applications, hereinafter referred to as “AR apps” or “AR effects”. The system is divided into two main sections: Lens Studio and the AI Lens Creator Backend 1706. The Lens Studio section contains the Lens Studio Plugin 1702, which includes a UI Webview 1704 that uses API Gateway for routing to the backend service. This plugin also incorporates a Lens Assembler 1722, which processes the Lens Recipe JSON to create the final AR app. Within the AI Lens Creator Backend 1706, the Mesh Service houses several key components, including a Web UI 1708, Server 1710, and CrewAI 1712. The Web UI 1708 maintains a local conversation history and communicates with the Server 1710 using HTTPS protocols, polling for new messages to enable real-time updates to the user interface. The Server 1710, as the central component of the backend, manages the conversation history and interacts with CrewAI 1712, a multi-agent system responsible for generating the AR app plan. It also manages a Message Queue 1714 for efficient communication between different parts of the system. CrewAI 1712 generates the AR app recipe based on user input and system capabilities.

The backend interacts with several external services, including an Auth Service 1724 for user authentication and authorization, Asset Providers 1716 (such as ComfyUI Generator, SnapML Generator, and Asset Collections) for generating or providing assets for the AR apps, Generated Asset Storage (BOLT) 1718 for storing generated assets, and a CMS (Contentful) 1720 for managing content and configurations for the system. The system operates by receiving user input through the Lens Studio Plugin 1702, which is then processed by the backend components. The CrewAI system 1712 generates a Lens Recipe JSON, which is sent back to the Lens Assembler 1722 in the plugin to create the final AR app.

This architecture allows for efficient communication between the user interface and the backend services, enabling real-time AR app creation based on user input. The use of a Mesh Service provides scalability and integration with existing infrastructure, while the modular design allows for easy expansion and modification of system capabilities.

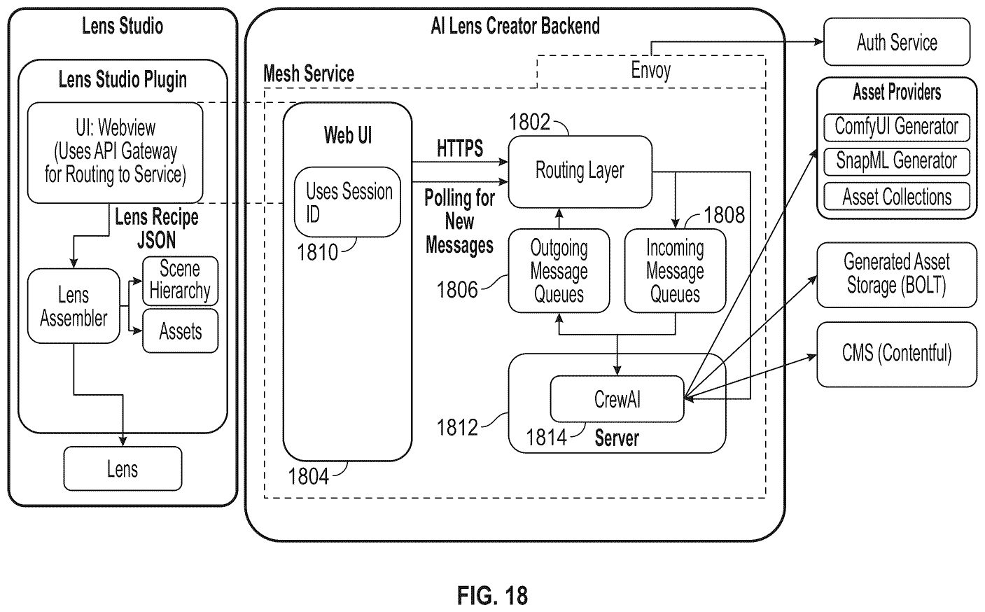

FIG. 18 builds upon the architecture presented in FIG. 17, introducing several key enhancements to improve the system's scalability and efficiency in handling multiple concurrent users. The primary addition in FIG. 18 is the Routing Layer 1802 within the AI Lens Creator Backend's Mesh Service.

This new Routing Layer 1802 serves as an intermediary between the Web UI 1804 and the Server components. It manages the flow of messages between users and the backend system, utilizing separate Outgoing Message Queues 1806 and Incoming Message Queues 1808. This queue-based approach allows for more efficient handling of multiple conversations simultaneously, reducing the risk of bottlenecks that could occur with direct communication.

Another significant change is the introduction of a Session ID 1810 in the Web UI component 1804. This Session ID 1810 is used to uniquely identify each user's conversation, allowing the system to maintain context and state for multiple users concurrently. The Web UI 1804 now communicates with the backend using this Session ID 1810, enabling more precise routing of messages and responses.

The Server component 1812 in FIG. 18 has been streamlined, with the CrewAI system 1814 now directly integrated into it. This integration allows for more efficient processing of user requests and generation of AR application recipes. The Message Queue from FIG. 17 has been replaced by the more sophisticated Incoming 1808 and Outgoing Message Queues 1806 managed by the Routing Layer 1802.

These enhancements collectively enable the system to handle a larger number of concurrent users more efficiently, while maintaining the context and state of each individual conversation. The queue-based architecture also provides better scalability and potential for load balancing in high-traffic scenarios.

The rest of the system, including the Lens Studio Plugin, Asset Providers, Generated Asset Storage, and CMS, remains largely unchanged from FIG. 17, maintaining compatibility with the existing infrastructure while benefiting from the improved message handling capabilities.

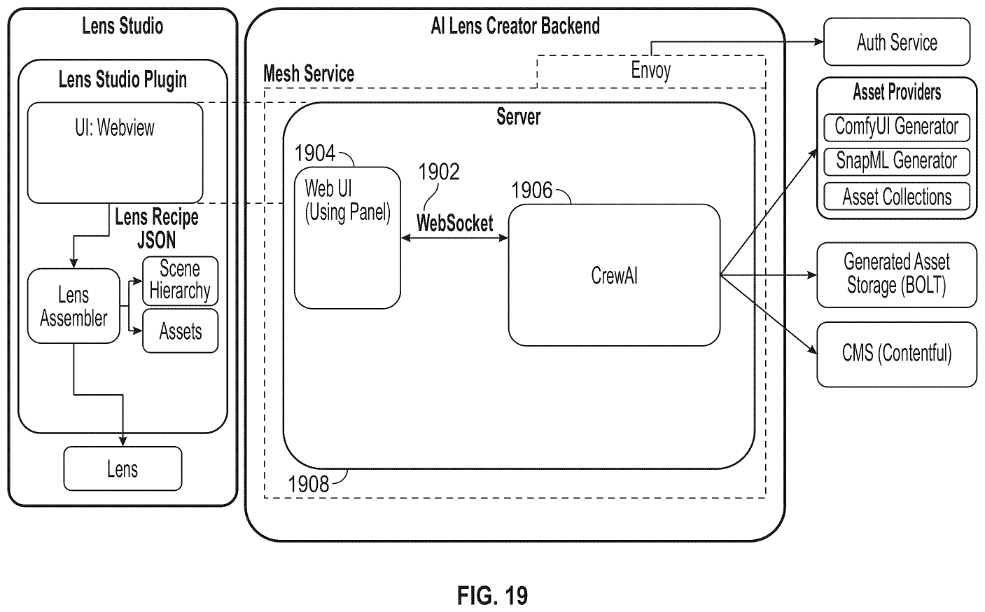

FIG. 19 builds upon the architectures presented in FIGS. 17 and 18, introducing a key enhancement to improve the system's real-time communication capabilities. The primary addition in FIG. 19 is the implementation of WebSocket communication 1902 between the Web UI 1904 and CrewAI 1906 components within the AI Lens Creator Backend's Mesh Service.

In this design, the Server component 1908 now houses both the Web UI (using Panel) 1904 and CrewAI 1906, connected via a WebSocket connection 1902. This direct WebSocket link 1902 allows for real-time, bidirectional communication between the user interface and the AI system responsible for generating the augmented reality (AR) application recipes. This approach potentially improves the responsiveness and interactivity of the system compared to the previous designs.

The use of WebSockets 1902 eliminates the need for the complex message queue system seen in FIG. 18. Instead of relying on separate Incoming and Outgoing Message Queues managed by a Routing Layer, the WebSocket connection 1902 enables direct, real-time message exchange between the Web UI 1904 and CrewAI 1906. This simplification in the communication architecture could lead to reduced latency and a more streamlined data flow within the system.

The rest of the system architecture remains largely unchanged from the previous figures. The Lens Studio Plugin, Asset Providers, Generated Asset Storage, and CMS components maintain their roles and connections. The Auth Service and Envoy components are still present, ensuring secure access to the Mesh Service.

This WebSocket-based design potentially offers improved performance and a more responsive user experience compared to the previous iterations, while maintaining the system's core functionality and integration with existing infrastructure.

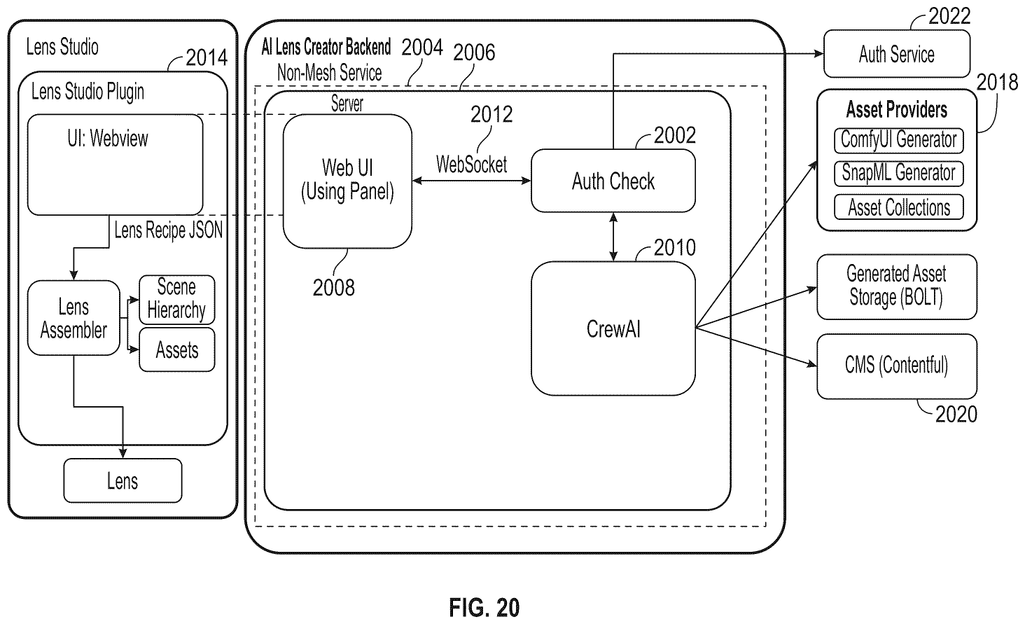

FIG. 20 builds upon the architectures presented in FIGS. 17, 18, and 19, introducing a key enhancement to improve the system's security and authentication capabilities. The primary addition in FIG. 20 is the implementation of an Auth Check component 2002 within the AI-base AR content creation system's Backend Non-Mesh Service 2004.

In this design, the Server component 2006 now houses the Web UI (using Panel) 2008, Crew AI 2010, and the new Auth Check module 2002. The Auth Check module 2002 is responsible for verifying user authentication before allowing access to the CrewAI system 2010. This direct authentication check allows for more robust security measures compared to the previous designs.

The use of a Non-Mesh Service 2004 in this architecture differentiates it from the Mesh Service implementations seen in FIGS. 17, 18, and 19. This approach may offer more flexibility in terms of deployment and customization of the authentication process. However, it also requires the backend to handle authentication logic directly, rather than relying on the Mesh infrastructure for this functionality.

The WebSocket connection 2012 between the Web UI 2008 and the Server components 2006 is maintained in this design, preserving the real-time, bidirectional communication capabilities introduced in FIG. 19. This allows for responsive interaction between the user interface and the AI system responsible for generating the augmented reality (AR) application recipes.

The rest of the system architecture remains largely unchanged from the previous figures. The Lens Studio Plugin 2014, Asset Providers 2016, Generated Asset Storage 2018, and CMS components 2020 maintain their roles and connections. The Auth Service 2022 is still present, but now interacts directly with the Auth Check module 2002 within the Non-Mesh Service 2004.

This authentication-focused design potentially offers improved security and more granular control over user access compared to the previous iterations, while maintaining the system's core functionality and real-time communication capabilities.

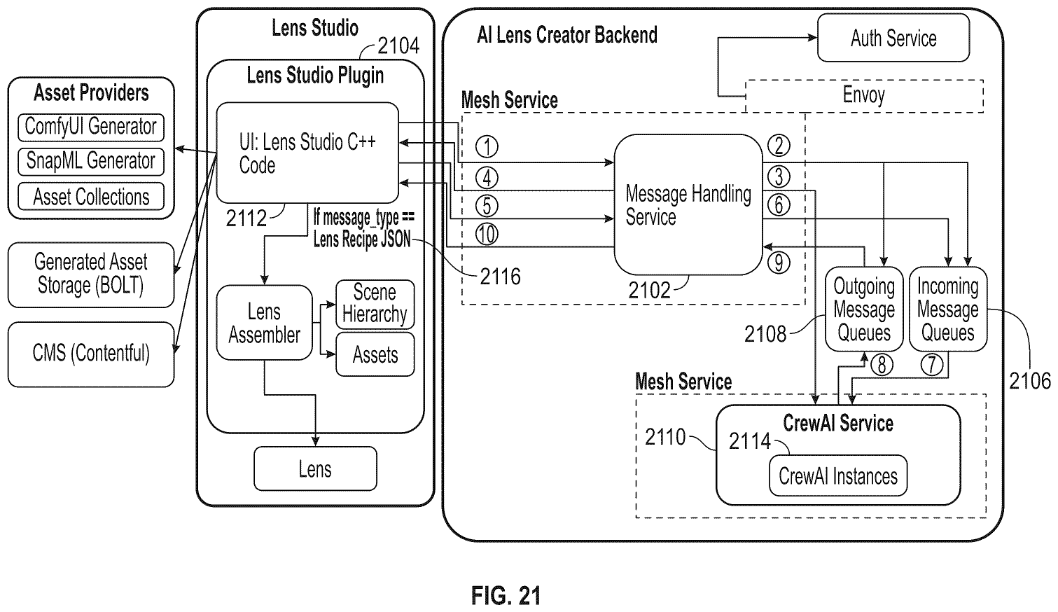

FIG. 21 introduces a Message Handling Service 2102 as a central component of the backend. This service manages communication between the Lens Studio Plugin 2104 and CrewAI instances, using separate Incoming 2106 and Outgoing Message Queues 2108. This design aims to improve scalability and responsiveness by efficiently routing messages between system components.

FIG. 21 builds upon the architectures presented in FIGS. 17, 18, 19, and 20, introducing several key enhancements to improve the system's scalability, efficiency, and integration capabilities. The primary addition in FIG. 21 is the implementation of a Message Handling Service 2102 within the AI Lens Creator Backend's Mesh Service.

The Message Handling Service 2102 acts as a central communication hub, managing the flow of messages between the Lens Studio Plugin 2104 and the CrewAI Service 2110. This new component replaces the direct communication methods seen in previous figures, providing a more robust and scalable approach to handling multiple user sessions and requests.

In this design, the Lens Studio Plugin 2104 now uses a native C++ UI 2112 instead of a Webview, which may offer improved performance and tighter integration with the Lens Studio environment. The Plugin 2104 communicates with the Message Handling Service 2102 through numbered steps (1-6), indicating a structured communication protocol.

The Message Handling Service 2102 interacts with both Outgoing Message Queues 2108 and Incoming Message Queues 2106, similar to the Routing Layer in FIG. 18. However, in this design, these queues are directly connected to the CrewAI Service 2110, which now contains multiple CrewAI Instances 2114. This architecture allows for better load balancing and concurrent processing of multiple user requests.

The CrewAI Service 2110 is now depicted as a separate Mesh Service, potentially allowing for independent scaling and management of the AI components. This separation of concerns could lead to improved system flexibility and easier maintenance.

Another notable change is the explicit handling of the Lens Recipe JSON 2116. The diagram shows that if the message type is a Lens Recipe JSON 2116, it is directly passed to the Lens Assembler within the Lens Studio Plugin 2104. This direct routing of the final output streamlines the process of creating the augmented reality (AR) application.

The rest of the system components, including Asset Providers, Generated Asset Storage, and CMS, remain largely unchanged from previous figures, maintaining compatibility with the existing infrastructure while benefiting from the improved message handling and processing capabilities.

This architecture potentially offers improved scalability, more efficient handling of multiple user sessions, and better integration with the Lens Studio environment compared to the previous iterations, while maintaining the system's core functionality and compatibility with existing services.

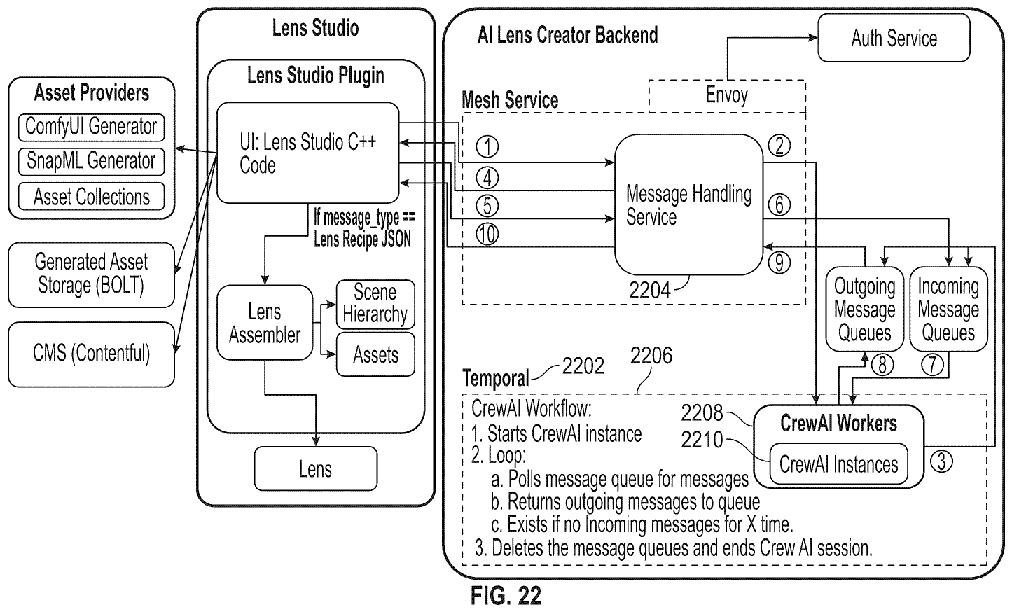

FIG. 22 presents an alternative design incorporating Temporal 2202, a workflow engine. In this implementation, the Message Handling Service 2204 triggers a Temporal CrewAI Workflow 2206, which manages the lifecycle of CrewAI instances and message queues. This approach potentially offers improved reliability and easier management of long-running processes. FIG. 22 builds upon the architectures presented in FIGS. 17-21, introducing a key enhancement to improve the system's workflow management and scalability. The primary addition in FIG. 22 is the implementation of Temporal 2202, a workflow engine, within the AI Lens Creator Backend's Mesh Service.

The Temporal CrewAI Workflow 2206 is introduced as a new component that manages the lifecycle of CrewAI instances and message queues. This workflow engine is responsible for three main tasks:
Starting a CrewAI instance
Managing a loop that:
a. Polls the message queue for messages
b. Returns outgoing messages to the queue
c. Exits if no incoming messages are received for a specified time.
Deleting the message queues and ending the CrewAI session

This addition provides a more structured and automated approach to managing CrewAI instances and their associated message queues, potentially improving system reliability and resource management.

The Message Handling Service 2204 remains a central component, similar to FIG. 21, but now interacts with the Temporal workflow 2206. This interaction allows for better coordination between the user interface and the CrewAI instances, potentially improving the system's ability to handle multiple concurrent users and long-running processes.

The Lens Studio Plugin now uses native C++ code for its UI, consistent with FIG. 21. This change may offer improved performance and tighter integration with the Lens Studio environment compared to earlier WebView-based implementations.

The overall structure of the system, including the Asset Providers, Generated Asset Storage, and CMS, remains largely unchanged from previous iterations. However, the introduction of Temporal 2202 provides a new layer of orchestration and management for the CrewAI Workers 2208 and CrewAI Instances 2210, and message queues, potentially offering improved scalability, reliability, and ease of management for long-running processes in the AI Lens Creator system.

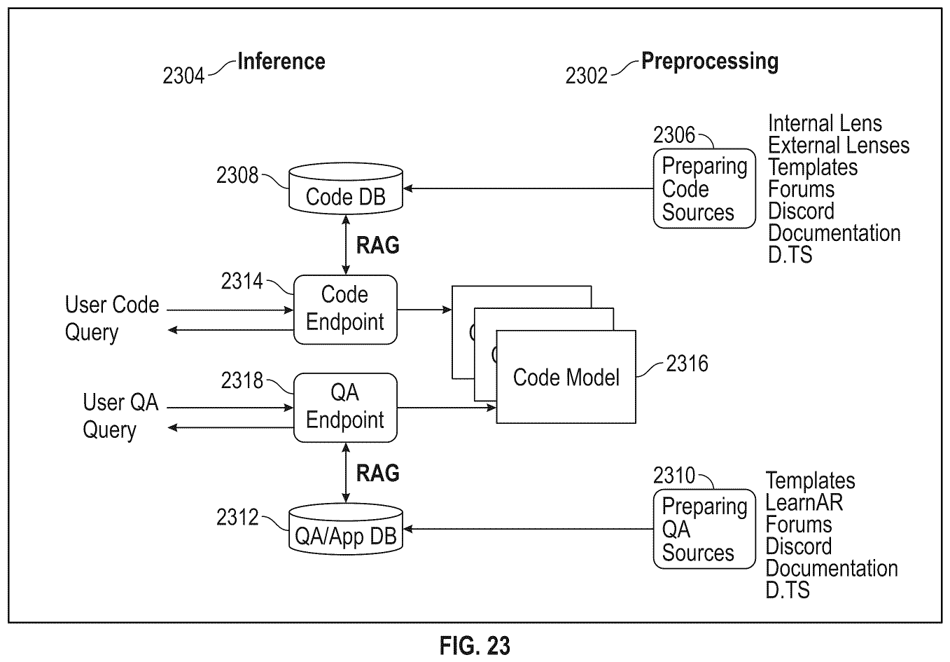

FIG. 23 is a diagram illustrating the preprocessing and inference stages of the AI-based AR content creation system. FIG. 23 illustrates the preprocessing and inference stages of the AI AR content creation system, which is designed to handle code and question-answering (QA) queries related to augmented reality (AR) application development.

The diagram is divided into two main sections: Preprocessing 2302 and Inference 2304. The Preprocessing section 2302 depicts the data preparation steps that enable the system's functionality, while the Inference section 2304 shows the runtime process of handling user queries.

In the Preprocessing stage 2302, two key processes occur:
Preparing code sources 2306: This process involves gathering and processing data from various sources, including internal and external AR applications, templates, forums, Discord discussions, documentation, and D.TS files. The preprocessed data is then stored in the Code DB 2308.
Preparing QA sources 2310: Similar to code preparation, this process collects and processes data from templates, LearnAR, forums, Discord discussions, documentation, and D.TS files. The processed data is stored in the QA/app DB 2312.

The Inference section 2304 illustrates how the system handles user queries:
Code queries: When a user submits a code-related query, it is processed by the Code endpoint 2314. This endpoint uses Retrieval-Augmented Generation (RAG) to fetch relevant information from the Code DB 2308 and then utilizes a Code model 2316 to generate an appropriate response.
QA queries: User questions are handled by the QA endpoint 2318, which also employs RAG to retrieve relevant information from the QA/app DB 2312 before generating a response.

This architecture enables the AI-based AR content creation system to provide context-aware and relevant responses to user queries about code and general AR application development questions. By preprocessing and storing a wide range of relevant data, the system can draw upon a rich knowledge base to assist users in creating AR applications with minimal technical expertise.

The system's design allows for efficient handling of both code-related and general AR development queries, leveraging the preprocessed data to provide accurate and contextually relevant responses. This approach enhances the overall user experience by offering quick access to a vast repository of AR development knowledge and code examples, potentially accelerating the AR application creation process.

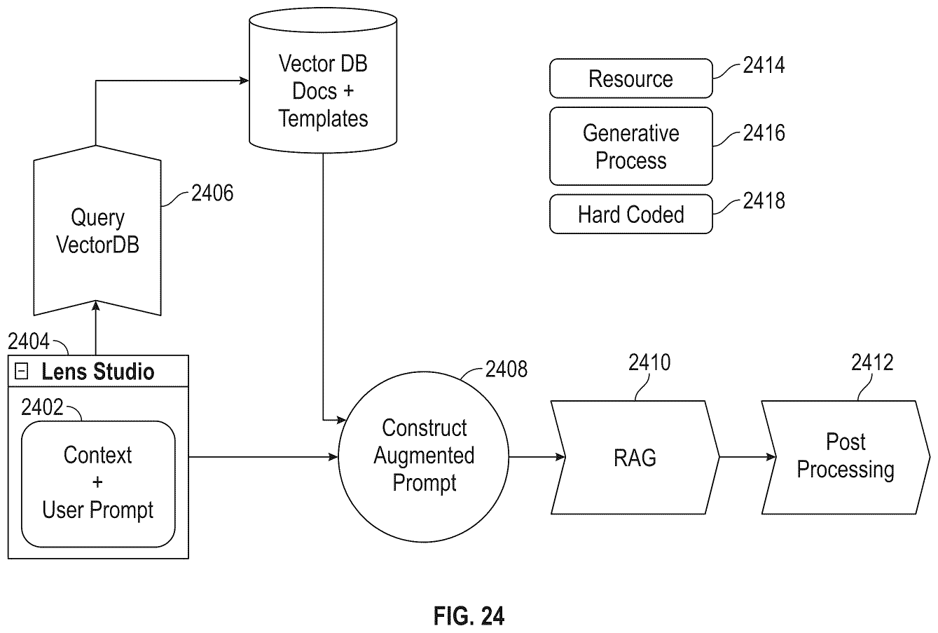

FIG. 24 is a diagram depicting the process of constructing augmented prompts using vector databases and user input. This figure depicts a workflow that enhances the system's ability to generate context-aware and relevant responses to user queries.

The process begins with the “Context+User Prompt” component 2402, which represents the initial input from the user within the Lens Studio environment 2404. This input is then processed through two parallel paths:
Vector Database Query: The user's input is used to query a Vector DB 2406 containing documentation and templates relevant to augmented reality (AR) application development. This step leverages similarity search techniques to retrieve the most relevant information based on the user's query.
Augmented Prompt Construction: The system combines the user's input with the retrieved relevant information from the Vector DB 2406 to construct an augmented prompt 2408. This augmented prompt 2408 is designed to provide more context and specificity to the subsequent generative processes.

The augmented prompt 2408 then undergoes Retrieval-Augmented Generation (RAG) 2410, a technique that enhances the quality and relevance of the generated output by incorporating retrieved information. This step is crucial for ensuring that the system's responses are grounded in accurate and up-to-date information about AR application development.

Finally, the output from the RAG process 2410 undergoes post-processing 2412, which may include formatting, filtering, or additional refinement to ensure the final response is suitable for presentation to the user within the Lens Studio environment 2404.

The diagram also indicates that certain components are categorized as “Resource” 2414 (yellow), “Generative Process” 2416 (pink), or “Hard Coded” 2418 (green). This categorization likely reflects the nature of each component's implementation within the system, distinguishing between static resources, dynamic generative processes, and fixed, programmed elements.

This augmented prompt construction process enables the AI AR content creation system to provide more accurate, context-aware, and relevant assistance to users creating AR applications, by leveraging both the user's input and a vast knowledge base of AR development information.

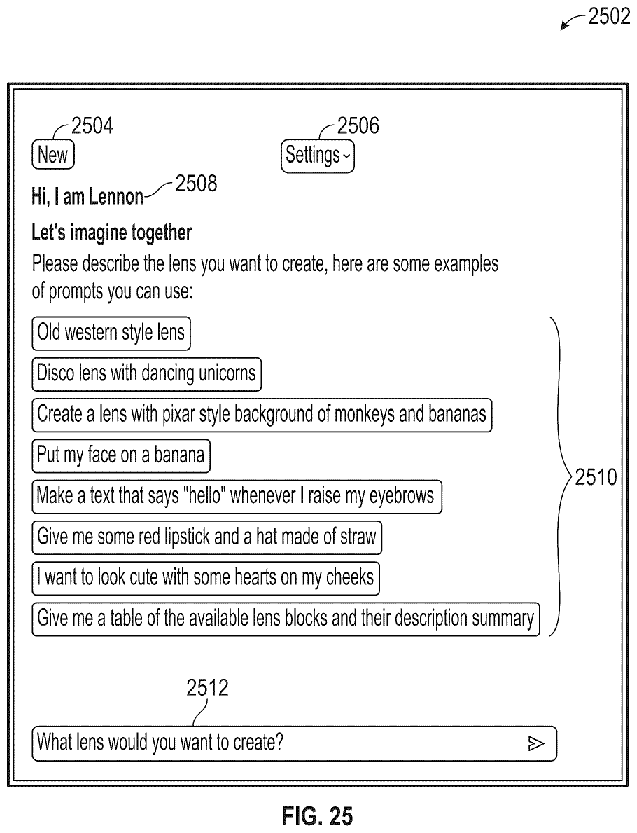

FIG. 25 illustrates the user interface 2502 for the AI AR content creation system, which is designed to facilitate the creation of augmented reality (AR) applications through a conversational interface.

The interface 2502 is presented as a chat window with a dark theme, featuring a virtual assistant named Lennon. The header of the interface includes a “New” button 2504 and a “Settings” dropdown menu 2506, providing users with options to start a new conversation or adjust system settings.

The main content area displays a greeting from Lennon 2508, stating “Hi, I am Lennon” and “Let's imagine together”. This personalized approach aims to create a friendly and collaborative environment for users.

Below the greeting, the interface provides instructions for users: “Please describe the lens you want to create, here are some examples of prompts you can use:”. This is followed by a list of example prompts 2510, which serve to guide users in formulating their own requests for AR application creation. The examples cover a wide range of creative possibilities, from style-based prompts (“Old western style lens”) to more specific feature requests (“Make a text that says ‘hello’ whenever I raise my eyebrows”).

The interface 2502 works by allowing users to input their desired AR application concept in natural language. Users can either use one of the provided examples as inspiration or create their own unique prompt based on their specific needs.

To create an AR experience, users engage in a conversation with Lennon 2508 by typing their request into the input field 2512 at the bottom of the interface. The system then processes this input using its underlying AI components, including the LLM Agents described in previous figures.

As users interact with the system, it may make recommendations to combine certain blocks or features to create the desired AR experience. For example, if a user requests a “Disco lens with dancing unicorns”, the system might suggest combining a background generator block for the disco setting, a 3D object generator for the unicorns, and an animation block to make the unicorns dance.

The system's ability to understand and process natural language inputs allows it to interpret complex requests and break them down into actionable components. For instance, the prompt “Give me some red lipstick and a hat made of straw” would likely trigger the system to use a facial feature modification block for the lipstick and a 3D headwear generator for the straw hat.

Throughout the conversation, users can refine their requests, ask for modifications, or explore different options. The AI assistant can provide feedback, ask clarifying questions, and offer suggestions to help users achieve their desired AR application.

This conversational approach to AR application creation significantly lowers the barrier to entry for users who may not have technical expertise in AR development. By abstracting away, the complexities of AR application creation into a simple chat interface, the system enables a wide range of users to bring their creative ideas to life in the form of interactive AR experiences.

### EXAMPLES

Example 1 is a computer-implemented method for automated creation of augmented reality experiences, comprising: receiving, via a conversational interface, a natural language description of a desired augmented reality experience from a user; processing the natural language description using a multi-agent system comprising a plurality of specialized large language model (LLM) agents, wherein the plurality of specialized LLM agents includes: a lens creator agent configured to generate high-level concepts for the augmented reality experience, an augmented reality engineer agent configured to decompose the concepts into a list of modular components and interaction specifications, and a designer agent configured to generate detailed parameters for the modular components; accessing a repository of predefined augmented reality blocks, wherein each block encapsulates a specific augmented reality functionality; selecting, by the augmented reality engineer agent, one or more of the predefined augmented reality blocks based on the high-level concepts; generating, by the designer agent, asset specifications for visual elements required by the selected augmented reality blocks using one or more asset generators; assembling the selected augmented reality blocks and generated assets into an executable augmented reality experience specification; and automatically generating an executable augmented reality application from the specification without requiring manual programming by the user.

In Example 2, the subject matter of Example 1 includes, wherein the plurality of specialized LLM agents further comprises: a critic agent configured to evaluate alignment between generated content and input prompts and provide feedback for iterative refinement when misalignment is detected.

In Example 3, the subject matter of Examples 1-2 includes, wherein generating the asset specifications comprises: utilizing a plurality of asset generators selected from the group consisting of: two-dimensional image generators for 2D image assets, garment generation systems for garment assets, three-dimensional accessory generators for headwear and eyewear assets, face mask generators, and generic three-dimensional object generators.

In Example 4, the subject matter of Examples 1-3 includes, wherein the predefined augmented reality blocks comprise blocks selected from the group consisting of: 3D object placement blocks, face mask application blocks, background replacement blocks, text overlay blocks, particle effect blocks, color filter blocks, garment application blocks, and facial expression event trigger blocks.

In Example 5, the subject matter of Examples 1-4 includes, receiving user feedback regarding the generated augmented reality application; and iteratively refining the augmented reality experience specification by re-engaging the multi-agent system with the user feedback to generate an updated specification.

In Example 6, the subject matter of Examples 1-5 includes, wherein assembling the selected augmented reality blocks and generated assets comprises: generating a structured lens recipe in JSON format containing: a list of named blocks with detailed parameters and high-level descriptions, and a list of event triggers for interactive functionality.

In Example 7, the subject matter of Examples 1-6 includes, storing the predefined augmented reality blocks and associated metadata in a content management system; collecting analytics data regarding usage patterns of the generated augmented reality applications; and utilizing the analytics data to inform future augmented reality block selections by the augmented reality engineer agent.

Example 8 is a system for automated creation of augmented reality experiences, the system comprising: one or more processors; and one or more storage devices storing instructions thereon, which, when executed by the one or more processors cause the system to perform operations comprising: receiving, via a conversational interface, a natural language description of a desired augmented reality experience from a user; processing the natural language description using a multi-agent system comprising a plurality of specialized large language model (LLM) agents, wherein the plurality of specialized LLM agents includes: a lens creator agent configured to generate high-level concepts for the augmented reality experience, an augmented reality engineer agent configured to decompose the concepts into a list of modular components and interaction specifications, and a designer agent configured to generate detailed parameters for the modular components; accessing a repository of predefined augmented reality blocks, wherein each block encapsulates a specific augmented reality functionality; selecting, by the augmented reality engineer agent, one or more of the predefined augmented reality blocks based on the high-level concepts; generating, by the designer agent, asset specifications for visual elements required by the selected augmented reality blocks using one or more asset generators; assembling the selected augmented reality blocks and generated assets into an executable augmented reality experience specification; and automatically generating an executable augmented reality application from the specification without requiring manual programming by the user.

In Example 9, the subject matter of Example 8 includes, wherein the plurality of specialized LLM agents further comprises: a critic agent configured to evaluate alignment between generated content and input prompts and provide feedback for iterative refinement when misalignment is detected.

In Example 10, the subject matter of Examples 8-9 includes, wherein generating the asset specifications comprises: utilizing a plurality of asset generators selected from the group consisting of: two-dimensional image generators for 2D image assets, garment generation systems for garment assets, three-dimensional accessory generators for headwear and eyewear assets, face mask generators, and generic three-dimensional object generators.

In Example 11, the subject matter of Examples 8-10 includes, wherein the predefined augmented reality blocks comprise blocks selected from the group consisting of: 3D object placement blocks, face mask application blocks, background replacement blocks, text overlay blocks, particle effect blocks, color filter blocks, garment application blocks, and facial expression event trigger blocks.

In Example 12, the subject matter of Examples 8-11 includes, receiving user feedback regarding the generated augmented reality application; and iteratively refining the augmented reality experience specification by re-engaging the multi-agent system with the user feedback to generate an updated specification.

In Example 13, the subject matter of Examples 8-12 includes, wherein assembling the selected augmented reality blocks and generated assets comprises: generating a structured lens recipe in JSON format containing: a list of named blocks with detailed parameters and high-level descriptions, and a list of event triggers for interactive functionality.

In Example 14, the subject matter of Examples 8-13 includes, wherein the operations further comprise: storing the predefined augmented reality blocks and associated metadata in a content management system; collecting analytics data regarding usage patterns of the generated augmented reality applications; and utilizing the analytics data to inform future augmented reality block selections by the augmented reality engineer agent.

Example 15 is one or more memory storage devices storing instructions thereon, which, when executed by one or more processors cause the one or more processors to perform operations comprising: receiving, via a conversational interface, a natural language description of a desired augmented reality experience from a user; processing the natural language description using a multi-agent system comprising a plurality of specialized large language model (LLM) agents, wherein the plurality of specialized LLM agents includes: a lens creator agent configured to generate high-level concepts for the augmented reality experience, an augmented reality engineer agent configured to decompose the concepts into a list of modular components and interaction specifications, and a designer agent configured to generate detailed parameters for the modular components; accessing a repository of predefined augmented reality blocks, wherein each block encapsulates a specific augmented reality functionality; selecting, by the augmented reality engineer agent, one or more of the predefined augmented reality blocks based on the high-level concepts; generating, by the designer agent, asset specifications for visual elements required by the selected augmented reality blocks using one or more asset generators; assembling the selected augmented reality blocks and generated assets into an executable augmented reality experience specification; and automatically generating an executable augmented reality application from the specification without requiring manual programming by the user.

In Example 16, the subject matter of Example 15 includes, wherein the plurality of specialized LLM agents further comprises: a critic agent configured to evaluate alignment between generated content and input prompts and provide feedback for iterative refinement when misalignment is detected.

In Example 17, the subject matter of Examples 15-16 includes, wherein generating the asset specifications comprises: utilizing a plurality of asset generators selected from the group consisting of: two-dimensional image generators for 2D image assets, garment generation systems for garment assets, three-dimensional accessory generators for headwear and eyewear assets, face mask generators, and generic three-dimensional object generators.

In Example 18, the subject matter of Examples 15-17 includes, wherein the predefined augmented reality blocks comprise blocks selected from the group consisting of: 3D object placement blocks, face mask application blocks, background replacement blocks, text overlay blocks, particle effect blocks, color filter blocks, garment application blocks, and facial expression event trigger blocks.

In Example 19, the subject matter of Examples 15-18 includes, wherein the operations further comprise: receiving user feedback regarding the generated augmented reality application; and iteratively refining the augmented reality experience specification by re-engaging the multi-agent system with the user feedback to generate an updated specification.

In Example 20, the subject matter of Examples 15-19 includes, wherein assembling the selected augmented reality blocks and generated assets comprises: generating a structured lens recipe in JSON format containing: a list of named blocks with detailed parameters and high-level descriptions, and a list of event triggers for interactive functionality.

Example 21 is at least one machine-readable medium including instructions that, when executed by processing circuitry, cause the processing circuitry to perform operations to implement of any of Examples 1-20.

Example 22 is an apparatus comprising means to implement of any of Examples 1-20.

Example 23 is a system to implement of any of Examples 1-20.

Example 24 is a method to implement of any of Examples 1-20.

We claim:

1. A computer-implemented method for automated creation of augmented reality experiences, comprising:
receiving, via a conversational interface, a natural language description of a desired augmented reality experience from a user;
processing the natural language description using a multi-agent system comprising a plurality of specialized large language model (LLM) agents, wherein the plurality of specialized LLM agents includes:
a lens creator agent configured to generate high-level concepts for the augmented reality experience,
an augmented reality engineer agent configured to decompose the concepts into a list of modular components and interaction specifications, and
a designer agent configured to generate detailed parameters for the modular components;
accessing a repository of predefined augmented reality blocks, wherein each block encapsulates a specific augmented reality functionality;
selecting, by the augmented reality engineer agent, one or more of the predefined augmented reality blocks based on the high-level concepts;
generating, by the designer agent, asset specifications for visual elements required by the selected augmented reality blocks using one or more asset generators;
assembling the selected augmented reality blocks and generated assets into an executable augmented reality experience specification; and
automatically generating an executable augmented reality application from the specification without requiring manual programming by the user.

2. The method of claim 1, wherein the plurality of specialized LLM agents further comprises:
a critic agent configured to evaluate alignment between generated content and input prompts and provide feedback for iterative refinement when misalignment is detected.

3. The method of claim 1, wherein generating the asset specifications comprises:
utilizing a plurality of asset generators selected from the group consisting of: two-dimensional image generators for 2D image assets, garment generation systems for garment assets, three-dimensional accessory generators for headwear and eyewear assets, face mask generators, and generic three-dimensional object generators.

4. The method of claim 1, wherein the predefined augmented reality blocks comprise blocks selected from the group consisting of:
3D object placement blocks, face mask application blocks, background replacement blocks, text overlay blocks, particle effect blocks, color filter blocks, garment application blocks, and facial expression event trigger blocks.

5. The method of claim 1, further comprising:
receiving user feedback regarding the generated augmented reality application; and
iteratively refining the augmented reality experience specification by re-engaging the multi-agent system with the user feedback to generate an updated specification.

6. The method of claim 1, wherein assembling the selected augmented reality blocks and generated assets comprises:
generating a structured lens recipe in JSON format containing:
a list of named blocks with detailed parameters and high-level descriptions, and
a list of event triggers for interactive functionality.

7. The method of claim 1, further comprising:
storing the predefined augmented reality blocks and associated metadata in a content management system;
collecting analytics data regarding usage patterns of the generated augmented reality applications; and
utilizing the analytics data to inform future augmented reality block selections by the augmented reality engineer agent.

8. A system for automated creation of augmented reality experiences, the system comprising:
one or more processors; and
one or more storage devices storing instructions thereon, which, when executed by the one or more processors cause the system to perform operations comprising:
receiving, via a conversational interface, a natural language description of a desired augmented reality experience from a user;
processing the natural language description using a multi-agent system comprising a plurality of specialized large language model (LLM) agents, wherein the plurality of specialized LLM agents includes:
a lens creator agent configured to generate high-level concepts for the augmented reality experience,
an augmented reality engineer agent configured to decompose the concepts into a list of modular components and interaction specifications, and
a designer agent configured to generate detailed parameters for the modular components;
accessing a repository of predefined augmented reality blocks, wherein each block encapsulates a specific augmented reality functionality;
selecting, by the augmented reality engineer agent, one or more of the predefined augmented reality blocks based on the high-level concepts;
generating, by the designer agent, asset specifications for visual elements required by the selected augmented reality blocks using one or more asset generators;
assembling the selected augmented reality blocks and generated assets into an executable augmented reality experience specification; and
automatically generating an executable augmented reality application from the specification without requiring manual programming by the user.

9. The system of claim 8, wherein the plurality of specialized LLM agents further comprises:
a critic agent configured to evaluate alignment between generated content and input prompts and provide feedback for iterative refinement when misalignment is detected.

10. The system of claim 8, wherein generating the asset specifications comprises:
utilizing a plurality of asset generators selected from the group consisting of: two-dimensional image generators for 2D image assets, garment generation systems for garment assets, three-dimensional accessory generators for headwear and eyewear assets, face mask generators, and generic three-dimensional object generators.

11. The system of claim 8, wherein the predefined augmented reality blocks comprise blocks selected from the group consisting of:
3D object placement blocks, face mask application blocks, background replacement blocks, text overlay blocks, particle effect blocks, color filter blocks, garment application blocks, and facial expression event trigger blocks.

12. The system of claim 8, further comprising:
receiving user feedback regarding the generated augmented reality application; and
iteratively refining the augmented reality experience specification by re-engaging the multi-agent system with the user feedback to generate an updated specification.

13. The system of claim 8, wherein assembling the selected augmented reality blocks and generated assets comprises:
generating a structured lens recipe in JSON format containing:
a list of named blocks with detailed parameters and high-level descriptions, and
a list of event triggers for interactive functionality.

14. The system of claim 8, wherein the operations further comprise:
storing the predefined augmented reality blocks and associated metadata in a content management system;
collecting analytics data regarding usage patterns of the generated augmented reality applications; and
utilizing the analytics data to inform future augmented reality block selections by the augmented reality engineer agent.

15. One or more memory storage devices storing instructions thereon, which, when executed by one or more processors cause the one or more processors to perform operations comprising:
receiving, via a conversational interface, a natural language description of a desired augmented reality experience from a user;
processing the natural language description using a multi-agent system comprising a plurality of specialized large language model (LLM) agents, wherein the plurality of specialized LLM agents includes:
a lens creator agent configured to generate high-level concepts for the augmented reality experience,
an augmented reality engineer agent configured to decompose the concepts into a list of modular components and interaction specifications, and
a designer agent configured to generate detailed parameters for the modular components;
accessing a repository of predefined augmented reality blocks, wherein each block encapsulates a specific augmented reality functionality;
selecting, by the augmented reality engineer agent, one or more of the predefined augmented reality blocks based on the high-level concepts;
generating, by the designer agent, asset specifications for visual elements required by the selected augmented reality blocks using one or more asset generators;
assembling the selected augmented reality blocks and generated assets into an executable augmented reality experience specification; and
automatically generating an executable augmented reality application from the specification without requiring manual programming by the user.

16. The one or more memory storage devices of claim 15, wherein the plurality of specialized LLM agents further comprises:
a critic agent configured to evaluate alignment between generated content and input prompts and provide feedback for iterative refinement when misalignment is detected.

17. The one or more memory storage devices of claim 15, wherein generating the asset specifications comprises:
utilizing a plurality of asset generators selected from the group consisting of: two-dimensional image generators for 2D image assets, garment generation systems for garment assets, three-dimensional accessory generators for headwear and eyewear assets, face mask generators, and generic three-dimensional object generators.

18. The one or more memory storage device of claim 15, wherein the predefined augmented reality blocks comprise blocks selected from the group consisting of:
3D object placement blocks, face mask application blocks, background replacement blocks, text overlay blocks, particle effect blocks, color filter blocks, garment application blocks, and facial expression event trigger blocks.

19. The one or more memory storage device of claim 15, wherein the operations further comprise:
receiving user feedback regarding the generated augmented reality application; and
iteratively refining the augmented reality experience specification by re-engaging the multi-agent system with the user feedback to generate an updated specification.

20. The one or more memory storage devices of claim 15, wherein assembling the selected augmented reality blocks and generated assets comprises:
generating a structured lens recipe in JSON format containing:
a list of named blocks with detailed parameters and high-level descriptions, and
a list of event triggers for interactive functionality.
